(19) United States
(12) Patent Application Publication
(10) Pub. No.: US 2026/0149747 A1
(43) Pub. Date: May 28, 2026

(54) Methods and Apparatus for Using Augmented Reality to Facilitate Network Device Management

(71) Applicant: Charter Communications Operating, LLC, St. Louis, MO (US)

(72) Inventor: Patrick Hunter, Saint Charles, MO (US)

(21) Appl. No.: 18/957,576

(22) Filed: Nov. 22, 2024

(51) Int. Cl. H04L 67/125; G06T 19/00; G06V 20/50

(52) U.S. Cl. CPC H04L 67/125; G06T 19/006; G06V 20/50

(57) ABSTRACT

Methods and apparatus for using augmented reality (AR) for network device management, including device configuration, are described. The methods and apparatus allow a device manager to view network devices on a screen of a mobile device which captures an image of the actual network devices. The mobile device may be a notepad, cellphone, or laptop which includes a camera for capturing pictures to the devices. The location of the mobile device, and thus the location of the network devices whose images are captured, is determined. Devices are identified in a captured image and device information is provided in an augmented realty image displayed to a network device manager using the mobile device. The manager can initiate a terminal session and change device settings while viewing an AR image and/or network devices on a display of the mobile device with the network devices appearing as if being viewed through the display.

### FIELD

The present application relates to network device management and, more particularly, to methods and apparatus which facilitate network device management through the use of augmented reality.

### BACKGROUND

Network devices such as switches, routers, access points, etc. can be located in a variety of locations throughout an office, business facility or other location. For locations with a large amount of network devices, the devices are often located in an equipment rack with an individual equipment rack often including multiple devices at different positions in the rack. Multiple equipment racks are often included in a single room, e.g., along a wall or in a row.

The grouping of equipment in a room in racks facilitates maintenance and allows, in the case of rooms dedicated to network equipment, for the equipment to be kept in an environmentally controlled, e.g., temperature or humidity controlled, room to thereby prevent equipment overheating or other potential equipment issues that might be associated with a less controlled environment.

Network equipment managers may have to make changes to settings relating to individual network devices at one location but not others. The changes may involve activating/starting or stopping various functions on a device or changing the settings associated with an individual device. In addition, device status may be changed from online to offline with such changes being made as part of device maintenance reasons or for other reasons. When online, a network device provides services to other devices while when off-line the network device normally does not provide services to other devices on the network to which the device is attached.

While status lights are often included on devices such as switches and routers, an equipment rack and/or room may include multiple switches/routers of the same type. A network manager viewing an equipment rack may find it difficult to determine precisely which piece of network equipment is being viewed when looking at an equipment rack. Thus, even if an offline or fault indicator light is activated, a network manager may have difficulty determining which network device the indicator light corresponds to. Given the number of wires and cables included in an equipment room/rack, and/or the presence of doors at the front of an equipment rack, a network manager may have difficulty viewing indicator lights to determine the status of a network device even when such lights are present on a device.

From the above it should be appreciated that a network device manager may have difficulty identifying devices and/or determining the status of devices even when physically present in the room where the network device or devices are located.

While in a room with multiple network devices, a network device manager may try a “trial-and-error” approach of having to plug into each device and log into them until the network device manager finds a device for which he/she is looking, Such an approach can be time consuming and inefficient with multiple devices having to be physically connected to before the device being sought can be identified.

From the above it should be appreciated that there is a need for improved methods and/or apparatus which could facilitate device identification and/or management of network devices by a network device manager at a site where a network device or multiple network devices are located.

### SUMMARY

Methods and apparatus for using augmented reality (AR) for network device management, including device configuration, are described. The methods and apparatus allow a device manager to view network devices on a screen of a mobile device such as a notepad device, cellphone, or laptop which includes a camera for capturing pictures to the devices. The screen can be and sometimes is a touch-screen which serves as an input device in addition to serving as a display device. The location of the mobile device, and thus the location of the network devices, whose images are captured by the mobile device is determined, e.g., based on GPS information, user input, wireless signals received by the mobile device and/or the content of images captured by the mobile device. For example, GPS information may be, and sometimes is, used to determine the building in which the mobile device and network device equipment is located with an image of a room number or room identifier such as a room name being used to identify the room in which the mobile device is located. In other embodiments one or more received wireless signals, e.g., a signal communicating a wireless access point identifier, is used to determine the room/location in which the mobile device is located, and thus the room/location in which the network devices captured in one or more images by the mobile device, are located.

One or more images captured by the mobile device are communicated to a network management system and analyzed to identify equipment racks and/or network devices mounted in the equipment racks. In some embodiments the position of an equipment rack is determined based on analysis of the position of the rack in an image captured by the mobile device. Once an equipment rack is identified in an image, the devices in the rack are identified, e.g., based on the position of the devices within an image showing the devices in the identified rack.

To facilitate rack and device identification based on the content of captured images, a database is maintained of equipment rack locations within buildings along with information indicating which network devices are mounted in an equipment rack and the position within the rack that each of the network devices, mounted in the equipment rack, is located. Thus, in some embodiments a database maintains information indicating the address and/or GPS coordinates of customer premises, e.g., buildings, in which network devices are located, the location of equipment racks within the buildings and the position of individual network devices in the equipment racks. This information can be, and sometimes is, used to identify devices in a captured image, e.g., by mapping a device location in a rack to corresponding device information. This allows a network management system receiving an image, in some cases with additional information that can be used to determine the location where the image was captured, to identify individual network devices in the image. In some cases, the identification of the device and/or location can be done completely from the content of a captured image, e.g., where the image includes a location, rack and/or device identifier which is visible in the captured image.

In various embodiments the network management system includes an augmented reality engine. The augmented reality can, and sometimes does, process received images to determine a location, identify a rack and/or identify device(s) in a captured image. In addition to deriving information about location, racks and/or devices from one or more captured images, the network management system also generates augmented image content including information corresponding to identified network devices. The augmented image content can include, for an individual identified device, status information, configuration settings, and an identifier of the identified device. When a captured image includes multiple identified devices, the augmented image content can include such information for each identified device in an image to which the augmented information corresponds.

The augmented image content can be, and sometimes is, in the form of information, e.g., content, intended to be overlaid on a captured image along with information about where in an image being generated such information is to be placed. In some such embodiments a mobile device will combine the augmented image content with the content of a captured image to generate an augmented reality image which is then displayed. The image with which the augmented image content is combined, e.g., overlayed, may be the image used to identify the network devices or another image.

In some embodiments video is captured by the mobile device with the video being a sequence of captured images. The video may be, and sometimes is, at a frame rate, e.g., 30 frames or images per second, which is faster than the update rate of the network device information being shown in the augmented reality images being generated. In some such embodiments augmented image content is combined in real time to generate the augmented reality video with device identification and/or status information being updated at a rate slower than the frame rate of the displayed video. The use of a slower device status/information update rate than the frame rate is acceptable for most applications given that the human network device manager normally takes several seconds or even minutes to respond to a change in network device status. By using a lower device information update rate than frame rate, the processing burden on an augmented reality engine generating augmented image content is reduced, as compared to other embodiments where the information in augmented image content is updated at the same rate images are captured and/or augmented reality images are generated and displayed.

While in some embodiments the mobile device, acting as a playback device, generates one or more augmented reality images by combining captured image content with augmented image content, in other embodiments the augmented image content is in the form of one or more augmented reality images which can simply be displayed by the mobile communications device. In such embodiments the augmented reality engine in the network management system combines information corresponding to one or more identified devices with a captured image provided by the mobile device to generate an augmented reality image which is returned as the augmented reality image content to the mobile device. In such an embodiment the mobile device simply displays the received augmented reality image which includes the device information without having to perform an image combining operation. In cases where the network management system is implemented outside the mobile device, this relieves much of the image processing burden that would otherwise be placed on the mobile device with regard to combining captured image content with augmented reality image content.

While an augmented reality image, including network device status and/or setting information, is being displayed on the display device of the mobile device to a network device manager, the mobile device is monitored for user input. The user of the mobile device, e.g., network device manager, can select to see more detailed information about an identified device, select to initiate a terminal session allowing more device information to be displayed and/or changed and/or take other actions to change the status of or manage the network devices shown in the augmented reality image.

By using a mobile device and augmented reality features, a network device manager can easily identify network devices visible to the network device manager, obtain device status and setting information and even initiate terminal sessions to control individual network devices. This can be done without the network manager having to identify network devices on his/her own and without the need for physically connecting to the network devices, since the interaction with the network management system and terminal sessions can be, and sometimes are, implemented via wireless network connectivity, e.g., using a wireless connection for at least part of the communications path used by the mobile device to interact with the network management system and/or network devices being managed/controlled.

While in many cases the network management system with augmented reality capability information is implemented as a separate system from the mobile device, in some embodiments the network management system is integrated into the mobile device. In such cases the mobile device interacts with and accesses network device and/or status information as needed via a wireless or wired connection to the communications network while the functions of the augmented reality image are performed by the mobile device. Thus, while in many embodiments the network management system and mobile device are separate physical devices, in other embodiments the network management system with augmented reality capability is part of the mobile device.

It should be appreciated that not all the features discussed above need be included in all embodiments. The detailed description which follows describes additional features, details and embodiments of the invention which can be used alone or in combination.

### BRIEF DESCRIPTION OF THE FIGURES

FIG. 1 is a drawing of an exemplary communications system including racks of network devices and a mobile device with augmented reality (AR) capability that can be used to manage network devices in accordance with the present invention.

FIG. 2 illustrates the exemplary mobile device with AR capability shown in FIG. 1 in greater detail.

FIG. 3 illustrates the network management system with AR capability of FIG. 1 in greater detail.

FIG. 4 is a drawing showing a display of a mobile device with a captured image of a wall and ceiling of a room with equipment racks and various power supplies visible in the displayed image.

FIG. 5 shows the display of the mobile device with the displayed image being updated to show that scanning for racks is in progress.

FIG. 6 shows the display of the mobile device with the displayed image being updated to indicate that a first rack has been identified in the displayed image.

FIG. 7 shows the display of the mobile device having been updated to show that a second rack has been identified in addition to the first rack.

FIG. 8 shows the display of the mobile device having been augmented to show identification information associated with identified racks and devices along with device status information which is superimposed over an image including the identified racks and devices.

FIG. 9 shows a user of the mobile device providing input, by clicking a single time on the switch 1 online indication, to request detailed information corresponding to the selected device which in the example is switch 1.

FIG. 10 shows the display of an augmented reality image with detailed information corresponding to switch 1 which is displayed in response to the user selection shown in FIG. 9 that signaled that the user was seeking detailed information for switch 1.

FIG. 11 shows a user providing input, by clicking a single time on the switch 1 online indication while detailed information corresponding to the switch is displayed, to request that detailed information corresponding to the selected device stop being displayed.

FIG. 12 shows the updated display after the user selected to cease having detailed information corresponding to switch 1 displayed.

FIG. 13 shows a user providing input, by double clicking on switch 1 online indication while detailed information corresponding to the switch is displayed, to request that a terminal session with switch 1 be initiated.

FIG. 14 is a diagram showing an augmented reality image including the initiated terminal session with switch 1.

FIG. 15A is a first part of a flow chart showing a sequence of steps implemented in accordance with the invention.

FIG. 15B is a second part of a flow chart showing a sequence of steps implemented in accordance with the invention.

FIG. 15C is a third part of a flow chart showing a sequence of steps implemented in accordance with the invention.

FIG. 15D is a fourth part of a flow chart showing a sequence of steps implemented in accordance with the invention.

FIG. 15 is a diagram showing how FIGS. 15A, 15B, 15C and 15D can be combined to form a complete flow chart showing steps implemented in accordance with the invention.

### DETAILED DESCRIPTION

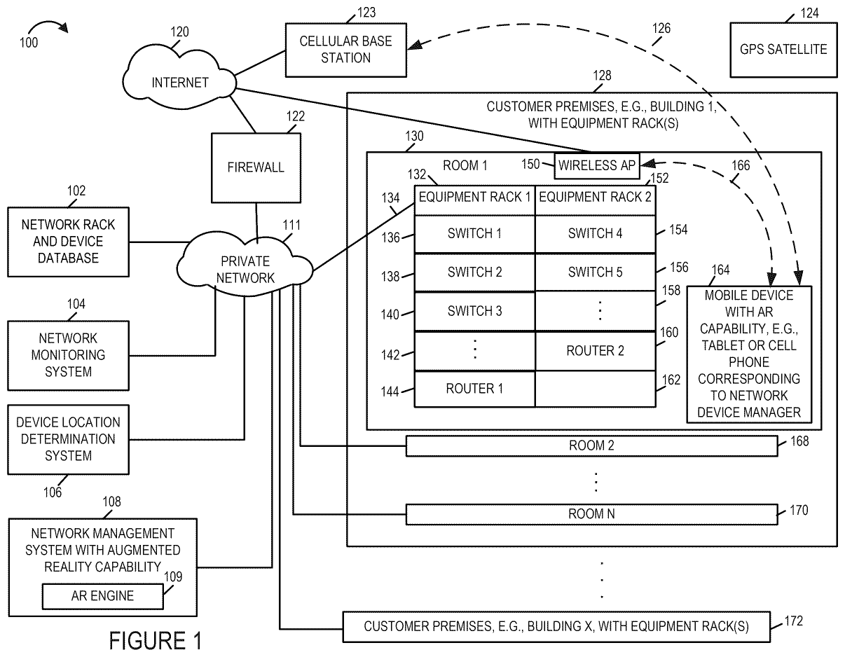

FIG. 1 is a drawing of an exemplary communications system 100 including a network management system 108 with augmented reality capability. The system 100 further includes a network rack and device database 102, a network monitoring system 104, and a device location determination system 106 which are coupled together and to customer premises 128 and 172 by a private network 111. Network connections which couple components to the private network 111 are shown as lines in the FIG. 1 diagram with line 134 connecting the components in the equipment racks 132, 152 to the private network 111 and thus the system components coupled thereto. The private network 111 is also coupled, via firewall 122, to the Internet 120. Devices on the private network 111 can send data to, and receive data from, a cellular base station 123 and/or wireless AP 150, thereby allowing devices with wireless capability to wirelessly interact with components coupled to the private network 111.

In the FIG. 1 example, a GPS satellite 124 is also shown. The GPS satellite transmits signals which can be detected, e.g., by mobile device 164, and which can be used by mobile device 164 to determine its location. The mobile device 164 can interact with other devices and network components wirelessly via the wireless AP 150 and/or cellular base station 123. Dashed lines 126 represent wireless signals corresponding to mobile device 164 communication via the cellular base station 123, while dashed line 166 represents wireless communication of signals corresponding to the mobile device 164 via wireless AP 150.

The network rack and device database 102 stores information about the geographic location of network devices including network devices in equipment racks 132, 152. For a given equipment rack, the database 102 normally stores information indicating the building and room within the building where the equipment rack is located and the position, e.g., vertical position, of individual network devices in a rack for which information is stored. Information which can be used to identify an equipment rack location, equipment rack and/or individual network device is also stored in some embodiments in the network rack and device database 102. For example, the database 102 may include information indicating a room name or number which can be visually detected in a captured image and/or a bar code or other room or device identifier which can be used to identify a room, rack or individual network device.

The information in network rack and device database 102 can be used to identify individual equipment racks and/or network devices in a captured image. This can be done based on location information (e.g., building address and room information and/or GPS coordinates) and captured image content (e.g., where rack position in a room and/or device position in a rack is determined from an image) and/or from captured image content alone, e.g., where visible identifiers used to identify network devices, equipment racks and/or the room in which the racks are located are visible in a captured image. Given information about the location of an equipment rack the position of a network device in the equipment rack, the information in the network rack and device database can be used to identify an individual network device in a captured image. In some embodiments the augmented reality engine 109 included in the network management system 108 accesses and uses the information stored in the network rack and device database 102 to identify network devices visible in one or more images captured by the mobile device 164.

Network monitoring system 104 monitors the status and settings of network devices in the system 100 including the individual devices in the equipment racks 132, 152. The network management system 108 can, and sometimes does, access the information in the network monitoring system 104 to obtain status and configuration information to be displayed with regard to individual identified devices visible in an image captured by the mobile device 164. Such information can be, and sometimes is, provided as augmented reality image content to the mobile device so that it can be displayed superimposed on a captured image allowing a user of the mobile device 164 to easily determine the identity and status of various network devices visible in an image captured by the mobile device 164 and being displayed to a user of the mobile device 164, e.g., a network device manager. The network device manager, via mobile device 164, can request detailed information corresponding to a network device and even initiate a terminal session with the network device via the mobile device 164 and network management system 108.

In various embodiments the mobile device may report its location to the network management system allowing the network management system to determine the location, e.g., building and/or room, from the location information provided by the mobile device 164. The location information may be in the form of GPS coordinates determined by the mobile device 164 based on received GPS signals and/or a building address entered by the user of the mobile device 164. In embodiments where wireless signals are used to determine the location of the mobile device 164, the device location determination system 106 may be provided with information from base stations and/or access points about signals received from the mobile device 164 or signals which the mobile device 164 detected receiving. In such cases, wireless signal information corresponding to the mobile device 164 is provided to the device location determination system 106, e.g., by base station 123 and/or wireless AP 150 and used to determine the location of the mobile device 164. The network management system 108 can query the device location determination system 106 for information about the location of the mobile device 164 in cases where location information is not received from the mobile device 164 and/or images received from the mobile device 164 are insufficient, alone or in combination with other information available at the network management system 108 to determine the location of the mobile device 164 and thus the racks 132, 152 and network devices in view of the camera of the mobile device 164.

The AR engine 109 in the network management system 108 receives and processes images captured by the mobile device 164 and communicates to the network management system 108. The AR engine 109 processes received images, e.g., images from the mobile device 164, to identify network devices 136, 138, 140, 144, 154, 156, 160, wireless AP 150 and/or racks 132, 153 to the extent they are visible in an image or images provided by the mobile device 164 after image capture by a camera 200 in the mobile device 164. The AR engine 109 can also process images to identify and detect room, rack and/or device identifier, e.g., bar codes, QR codes, text and/or numbers that can be useful for identifying the room, racks and/or devices which can be observed in an image captured by the mobile device 164 via its camera 200. In addition to processing captured images received at the network management system to identify devices and/or recover location, e.g., room, information, the AR engine 109 can also generate augmented image content to be communicated to the mobile device 164 for display to a user of the mobile device 164, e.g., a network device manager sometimes referred to as a system administrator.

In some embodiments the augmented image content is device information, e.g., device identification, status, and/or configuration information to be superimposed on an image or images captured by the mobile device along with information where the information is to be positioned in a captured image so that it is presented in a manner that the user device manager can easily determine the network device in the image to which the information relates. In some such embodiments the augmented image content is communicated to the mobile device 164 which then merges it with a captured image or images prior to display on display 230 of the mobile device 164. In such embodiments the mobile device 164 is responsible for generating the final augmented reality image which is displayed at a given time from a captured image and the augmented image content provided by the AR engine 109 of the network management system 108. Such image processing can be processor intensive from the perspective of the mobile device 164 due to the need to blend, e.g., superimpose, augmented reality image content on captured image content to generate the augmented reality image which is then displayed to the network device manager. The display 230 can be, and sometimes is, a touch-screen which can be used as an input device in addition to serving as a display device.

In other embodiments the augmented image content generated by the AR engine 109 is an augmented reality image which is generated by the AR engine 109 and communicated to the mobile device 164 for display. In such an embodiment, the AR engine 109 merges network device related information with a captured image to generate an AR image which can then be displayed by the mobile device 164 without the mobile device 164 having to do an image content merge operation to generate the augmented reality image which is displayed. This approach, while producing the same type of augmented reality image that is produced at the mobile device 164 when the content merge is performed in the mobile device 164, is less processor intensive at the mobile device 164 since the mobile device 164 does not have to perform the captured image content/device information content merge operation to produce the augmented reality image to be displayed.

While the network management system 108 with AR capability 109 is shown in the context of a system with one mobile device 164, it should be appreciated that the network management system 108 can, and sometimes does, support many mobile devices 164 at the same time with the mobile devices being potentially located at multiple different locations/customer premises. For example, mobile devices 164 can be located at any of customer premises 128 through 172 and in any of the rooms at such locations. Customer premises 128 is shown in greater detail than the other customer premises simply for purposes of explaining the invention, but it should be understood that the other customer premises can have similar or different numbers of rooms and/or equipment racks.

The first customer premises 128 in the example corresponds to a first building, with multiple equipment racks 132, 152 and rooms 130, 168, 170. The first and second equipment racks 132, 152 and devices mounted therein are coupled to the network monitoring system 104, network management system 108 and other network devices via connection 134 and private network 111. The first equipment rack 1 132 has a first switch 136 mounted in a top device position, a second switch 138 in a second from top device position, a third switch 140 in a third from top device position and a first router 144 in a lower most device position. The device positions correspond to device slots which are normally of a known fixed size. The dots in the device position area 142 represent additional device positions in which network devices can be, and sometimes are, mounted. Equipment rack 2 152 includes fourth switch 154 in a topmost device position and a fifth switch 156 in the next lowest device position. Dots in device position area 158 correspond to one or more device positions in which devices can be mounted. In the second from lowest device position a second router 160 is mounted while the lowest slot in rack 2 identified by reference number 162 is left empty.

The racks shown in FIG. 1 are exemplary and will be used in various examples to explain the invention. Various examples use the case where an image is taken in room 1 in the direction of the equipment racks 132, 152, e.g., by mobile device 164. In the case of an image with the racks 132, 152 being visible the racks 132, 152 and the devices in the racks can be identified based on known rack and device position information if the room in which the racks is located can be determined, e.g., based on GPS, user input or image content. While the rack position and device position information is used to identify devices based on the information stored in the network rack and device database 102 in cases where the racks and/or devices include visible labels, bar codes, text, QR codes or other identifiers, the AR engine 109 can identify the racks and/or devices from the visible information included in a captured image. For example, if the label “switch 1” and “equipment rack 1” shown on the corresponding rack and network device are captured in an image, the AR engine 109, can and sometimes does, identify these elements based on the detected label on or near the device or rack to which the label corresponds.

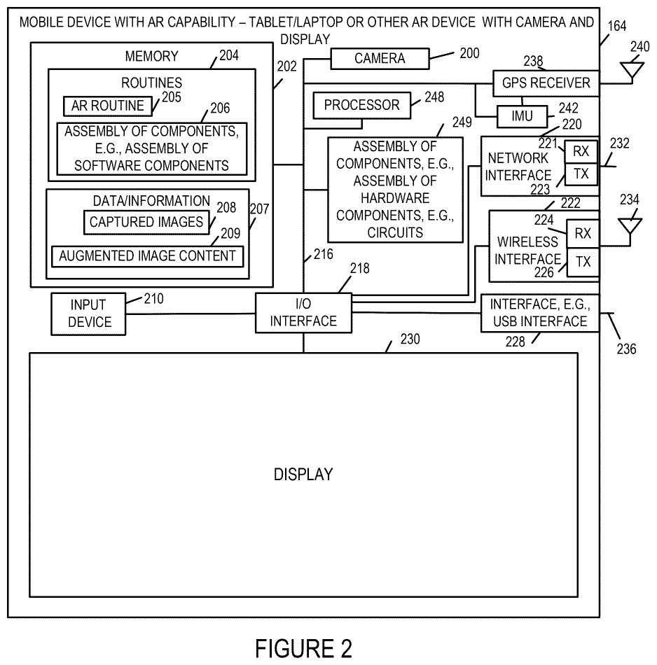

Having discussed the components of the system 100 with regard to FIG. 1, the mobile device 164 with AR capability will be discussed in greater detail. FIG. 2 shows an exemplary mobile device 164 with AR capability that can be used in the system of FIG. 1. The mobile device 164, which could be a notepad device, cellphone or other device, includes a camera 200, processor 248, memory 202, input device 210, assembly of components 249, I/O interface 218, display 230, GPS receiver 138, IMU 142, along with an interfaces 220, 222, 228, through which the mobile device 264 can communicate with other devices in the system 100 including the network management system 108.

In the FIG. 2 example, a bus 216 couples the camera 200, memory 202, processor 248, and an assembly of components 249, e.g., an assembly of hardware components such as circuits, GPS receiver 238, and IMU 242 to one another and to input/output (I/O) interface 218. The assembly of components 249, e.g., an assembly of hardware components, can, and sometimes does, include hardware circuits which perform the functions which would be performed by the described software routines 204 but through the use of hardware circuits.

The bus 216 allows the components coupled to it to communicate with one another and via the I/O interface 218 with input device 210, display 230 and the various interfaces 220, 222 and 228 through which the mobile device 164 can communicate with other devices. The first interface 220 is an electrical or optical interface which is connected to other devices by a cable 232 which could be an electrical or optical network cable. The first interface includes a receiver module or circuit 221 and a transmitter module or circuit 223 which are coupled to cable 232.

The input device 210 can include a mouse and/or keypad through which a user of the mobile device 164 can provide input, e.g., by clicking or double clicking on displayed images and/or by providing keyboard input which the processor 248 can detect and act upon. The display screen 230 can be and sometimes is a touch-screen which can serve as an input device which can be and sometimes is in addition to, or as an alternative to, the mouse and/or keypad.

The second interface 222 is a wireless interface including a receiver portion 224 and a transmitter portion 226 which are coupled to antenna 234. Via the wireless interface 222 the mobile device 164 can communicate with access points such as AP 150 and/or cellular base station 123. Thus, wireless interface 222 supports WiFi and cellular communications. The wireless receiver portion 224 of the wireless interface 222 includes a Wi-Fi receiver and a cellular receiver, while the wireless transmitter portion 226 of the wireless interface 222 includes a WiFi transmitter and a cellular transmitter. The wireless interface 222 is coupled to antenna 234, via which the mobile device 164 may receive and transmit wireless communications signals, e.g., WiFi signals and cellular signals. The third interface 228 is a USB interface which can receive input via cable 236.

The GPS receiver 238 receives GPS signals, via GPS antenna 240, and determines mobile device 164 position, based on the received GPS signals. The IMU (inertial measurement unit) 142, e.g., an IMU on a chip, includes gyroscopes and accelerometers, which perform measurements, and provide input to the GPS receiver 238, e.g., aiding the GPS receiver 238 in estimating position, e.g., when GPS reception is not optimal or is not available.

The processor 248 controls the mobile device 164 to operate in accordance with the invention under control of one or more of the routines 204 stored in the memory 202. The stored routines include an AR routine 205, which can be used to control the mobile device 164 to capture images, process captured images, communicate captured images to the network management system 108 and receive augmented image content from the network management system, e.g., augmented image content provided by the AR engine 109 of the network management system. Under control of the AR routine 205 the processor 248 can control the mobile device 164 to merge one or more captured images with augmented image content 209 including network device status or other network device information. Alternatively, where the augmented image content 209 already includes captured and merged device information, the AR routine 205 can cause the mobile device 164 to display the augmented reality image including the merged image content and rack/device information without burdening the processor 248 with the task of performing the merge to create the AR image. The AR routine 205 can also interact with the network management system 108 to initiate network device terminal sessions via which a device manager using the mobile device 164 can change network device settings, e.g., bring a device online or offline and/or alter the devices configuration. In addition to the AR routine 205, the mobile device includes an assembly of components 206, e.g., an assembly of software components, which when executed by the processor 248 control the mobile device 164 to operate in accordance with the invention.

In addition to the routines 204, the memory 202 includes data and information 207. The data/information 207 includes captured images 208 and augmented image content 209. The augmented image content 209 can be and sometimes is content received from the AR engine 109 of the network management system 108.

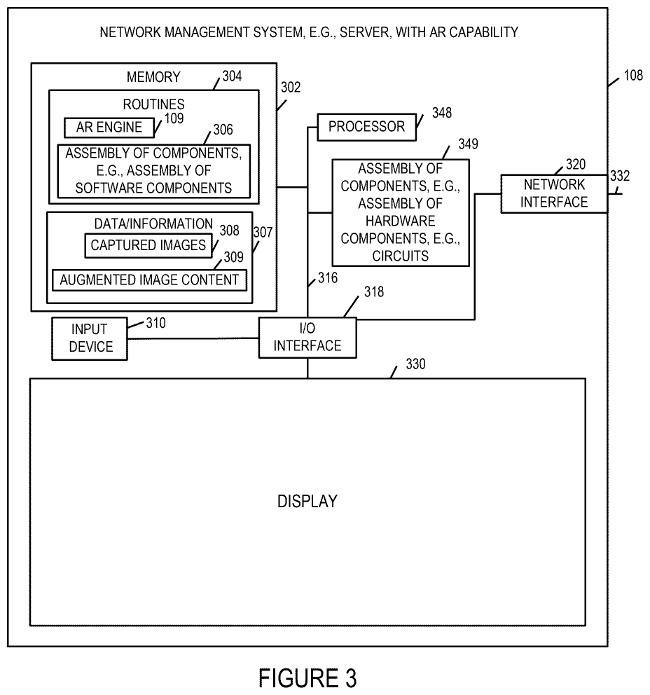

FIG. 3 illustrates the network management system 108 with augmented reality capability in greater detail. The network management system 108 includes components similar to the mobile device 164 but is implemented in many cases as a network device which interacts with mobile devices 164 as well as the various components coupled to the private network 111 such as the network rack and device database 102, network monitoring system 104 and device location determination system 106.

In the FIG. 3 example, a bus 316 couples memory 302, processor 348 and an assembly of components 349, e.g., an assembly of hardware components such as circuits, to an input/output (I/O) interface 318. The assembly of components 349 can, and sometimes does, include hardware circuits which perform the functions which would be performed by the described software routines 304 but through the use of hardware circuits.

The bus 316 allows the components coupled to it to communicate with one another and via the I/O interface 318 with input device 310, display 330 and the network interface 320 through which the network management system 108 can communicate with other devices. The network interface 320 is an electrical or optical interface which is connected to other devices via the private network 111. The cable 332 could be an electrical or optical network cable. Rather than use a wired network interface 320 in some embodiments a wireless interface is included in the network management system 108 with the wireless interface being in place of network interface 320 or in addition to the network interface 320. The input device 310 can include a mouse and/or keypad through which a user of the mobile device can provide input, e.g., by clicking or double clicking on displayed images and/or by providing keyboard input which the processor 348 can detect and act upon.

The processor 348 controls the network management system 108 to operate in accordance with the invention under control of one or more of the routines 304 stored in the memory 302. The stored routines include an AR engine 109, which is an AR routine, which can be used to receive and process images that were received from the mobile device 164. The AR engine 109 can also control the processor 348 to perform other AR related functions such as identify racks and/or network devices in captured images, retrieve device information, and generate augmented reality content which the AR engine 109 then controls the network management system 108 to provide to a mobile device 164.

Under control of the AR routine 109 the processor 348 can control the network management system 108 to merge one or more captured images with device information to generate augmented image content 309, e.g., an augmented reality image, including network device status or other network device information. In other embodiments the augmented image content 309 generated by the AR engine 109 includes network device information and merging information, which is provided to a mobile device 164 so that the mobile device 164 can merge, e.g., superimpose, the network device information with captured image content to generate an augmented reality image including device information.

In addition to the AR engine 109, the network management system 108 includes an assembly of components 306, e.g., an assembly of software components, which when executed by the processor 348, control the network management system 108 to operate in accordance with the invention.

In addition to the routines 304, the memory 302 includes data and information 307. The data/information 307 includes received captured images 308 and augmented image content 309.

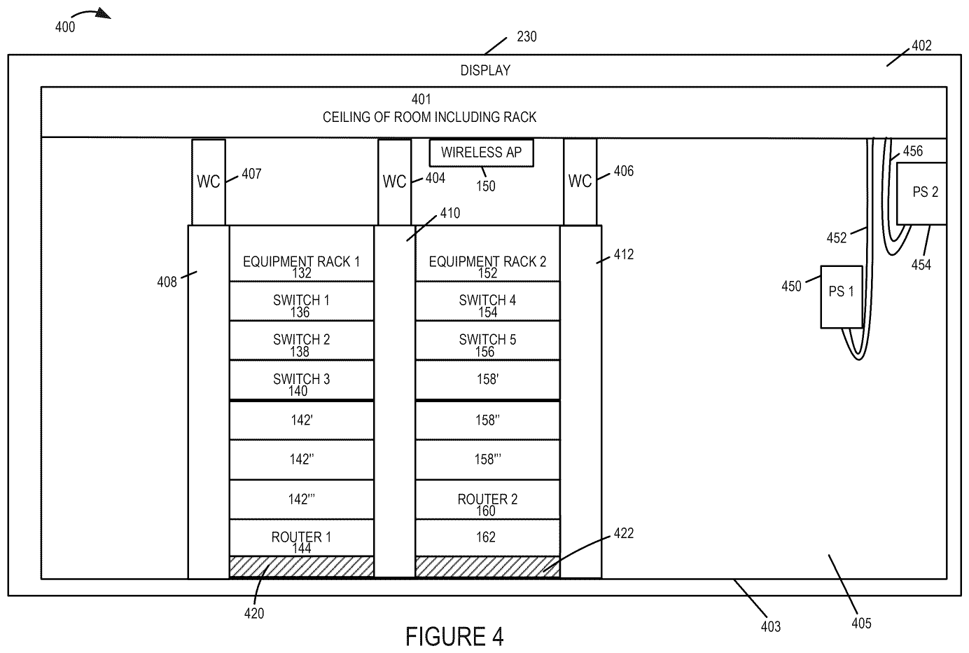

FIG. 4 is a drawing 400 showing the display 230 of the mobile device 164 with a captured image 405 being displayed in the viewing area defined by the inner portion 403 of the display frame 402. The displayed captured image 405 is an image taken in room 1 130 of customer premises 128 with the equipment first and second equipment racks 132, 152 being visible along a wall of the room on which wire chases WC 407, 404 and 406 are mounted allowing wires from the ceiling 401 to extend down to the devices in the equipment racks 132, 152 behind the rack panels 408, 410, 412 which are shown in the displayed image 405.

The network devices in equipment rack 1 132 include switch 1 136, switch 2 138, switch 3 140 and router 1 144. Unused device mounting positions 142′, 142′, 142′″ are visible in equipment rack 1 132. The unused slots 142′, 142″ and 142′″ correspond to the slot mounting positions represented in FIG. 1 by reference number 142. The network devices in equipment rack 2 152 include switch 4 154, switch 5 156, and router 2 160. Unused device mounting positions 158′, 158″, 158′″ and 162 are visible in equipment rack 2 152. The unused slots 158′, 158″ and 158′″ correspond to the slot mounting positions represented in FIG. 1 by reference number 158. At the base of the first and second racks are rack bases 420, 422. Base 420 is used to support the first equipment rack 132 and in some cases to secure the rack 132 to the floor of the room 130. The floor is not visible in FIG. 4 but corresponds to the edge of the display frame 403. Base 422 is used to support the second equipment rack 152 and in some cases to secure the rack 152 to the floor of the room 130.

In FIG. 4 the wireless AP 150 can be seen mounted to the ceiling 401 of the room 130 while various power supplies PS 1 450 and PS 2 454 can be seen mounted on the wall of the room 130. Cables 452, 456 allow power from the power supplies 452, 454 to be routed through the ceiling 401 and supplied to the wireless AP 150 and/or devices in the equipment racks 132, 152.

Note that in the displayed image 405 the mobile device 164 is not visible because the displayed image is being captured using the camera 200 of the mobile device 164 and the display 230 is the display of the mobile device 164. From the perspective of a user of the mobile device 164, the user is presented with image 405 as if looking through the display 230 and seeing the racks 132, 152 which are captured by the camera 200 which is positioned on the mobile device 164 behind the display 230.

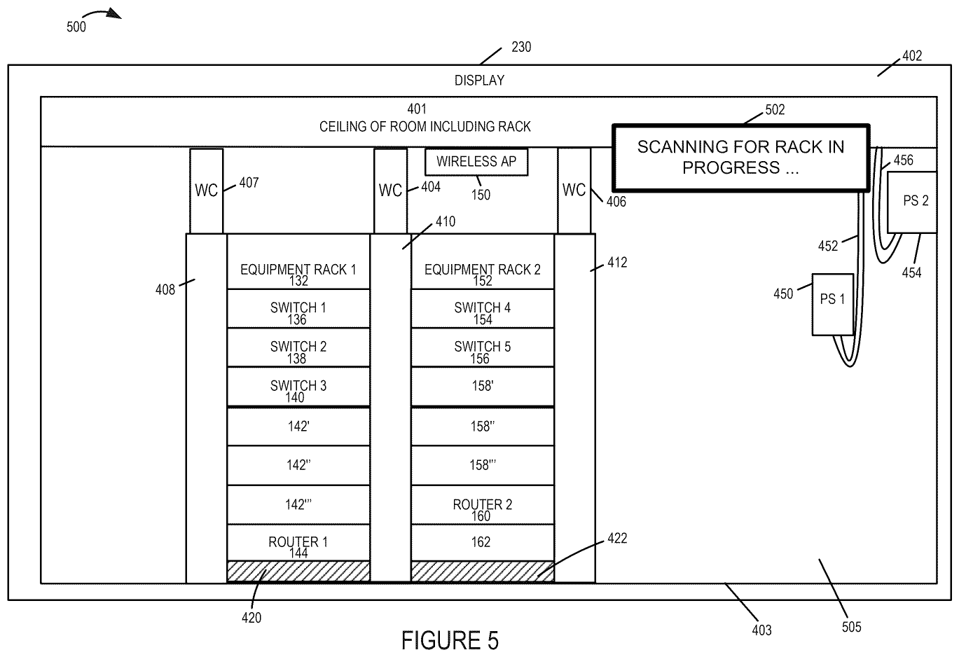

FIGS. 5-14 show a sequence of exemplary augmented reality images which are displayed as a network device administrator uses the mobile device 164 to interact with and control the network devices present in room 130 in accordance with the invention.

FIG. 5 is a drawing 500 showing the display 230 of the mobile device 164 with augmented reality image 505 being displayed. The augmented reality image 505 shows the captured image 405 after being updated to show that scanning for racks is in progress as indicated by scanning indication 502.

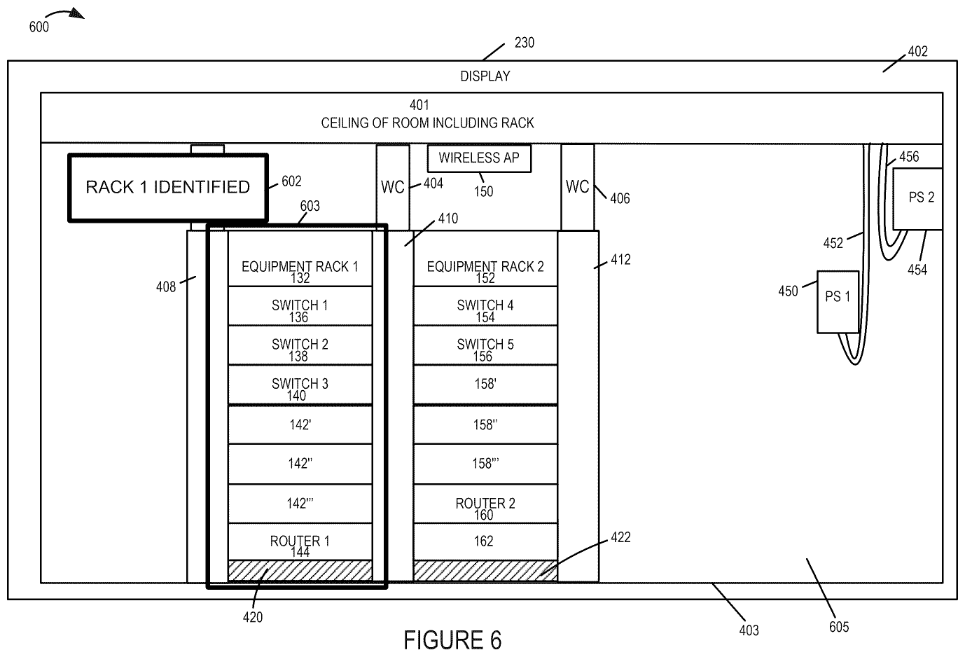

FIG. 6 is a drawing 600 showing the display 230 of the mobile device 164 with the displayed image being updated to show that a first rack 132 has been identified in the displayed image. The augmented reality image 605 includes rack identifier indicator 602 and corresponding rack bounding box 603.

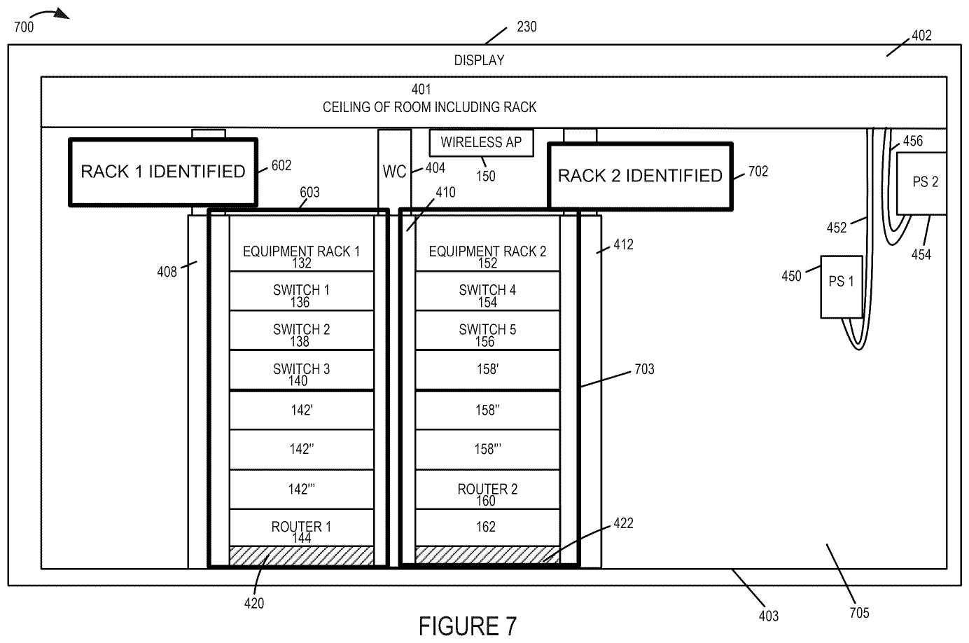

FIG. 7 is a drawing 700 showing the display 230 of the mobile device 164 having been updated to show that a second rack 152 has been identified in addition to the first rack 132. The augmented reality image 705 includes rack identifier indicator 702 and corresponding rack bounding box 703 in addition to the previously included rack identifier indicator 602 and corresponding rack bounding box 603.

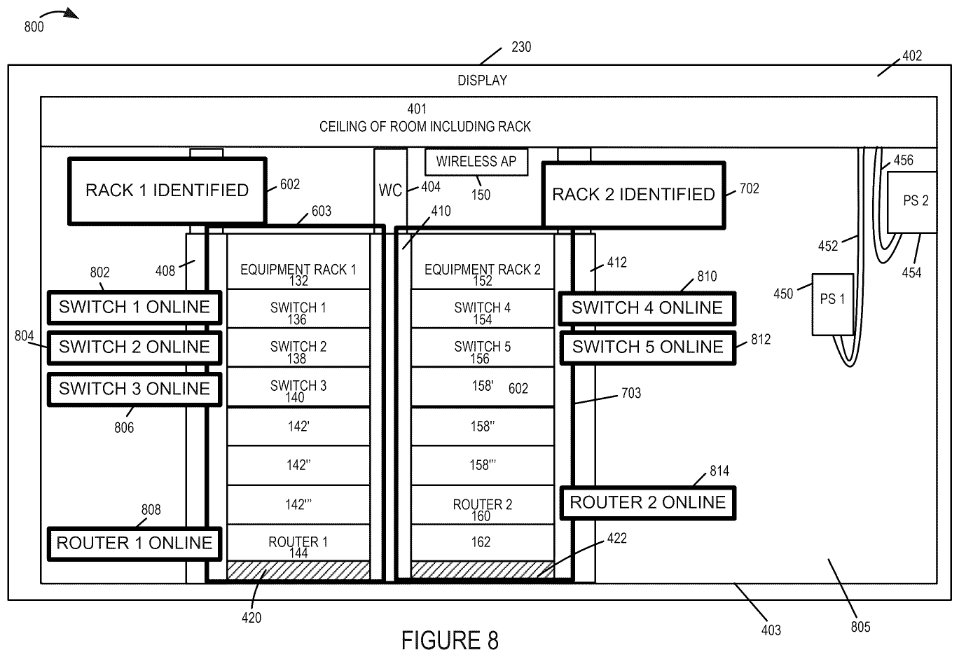

FIG. 8 is a drawing 800 showing the display 230 of the mobile device 164 having been augmented still further, after the AR engine 109 identifies network devices in image 405 to show identification information associated with devices along with device status information. The device identification and status information 802, 804, 806, 810, 812 and 814 is superimposed over an image including the identified racks and devices to generate the augmented reality image 805.

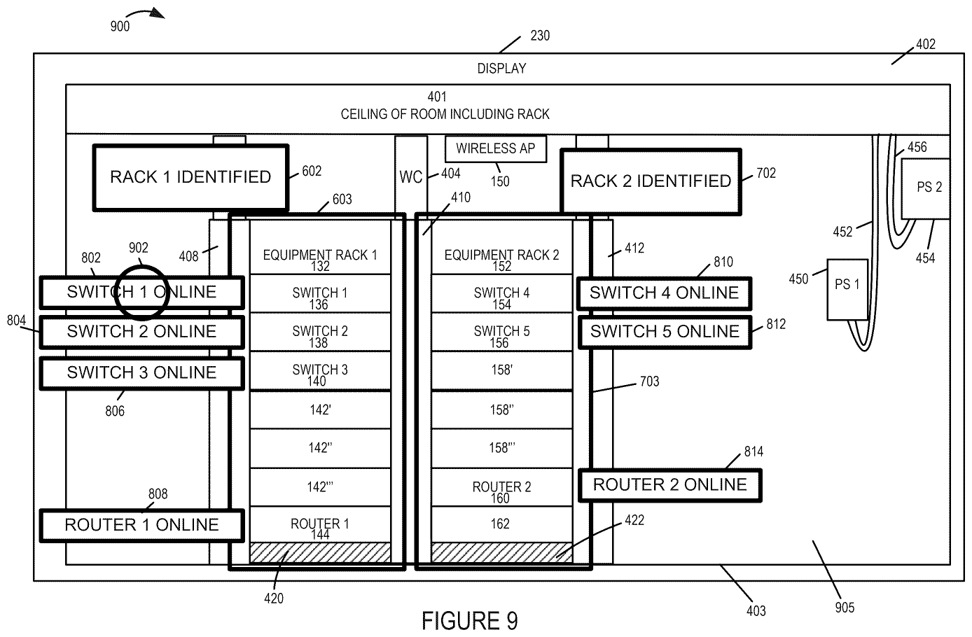

With the network devices having been identified and the online/offline status displayed to the user of the mobile device 164, the user can signal a desire for more detailed information corresponding to a device by clicking once on the displayed label/information corresponding to an identified device. FIG. 9 shows an augmented reality image 905 with a user of the mobile device 164 providing input, by clicking a single time on the switch 1 label/information 802, to request detailed information corresponding to the selected network device, i.e., switch 1 136. The single click is represented by the single circle 902 shown in FIG. 9.

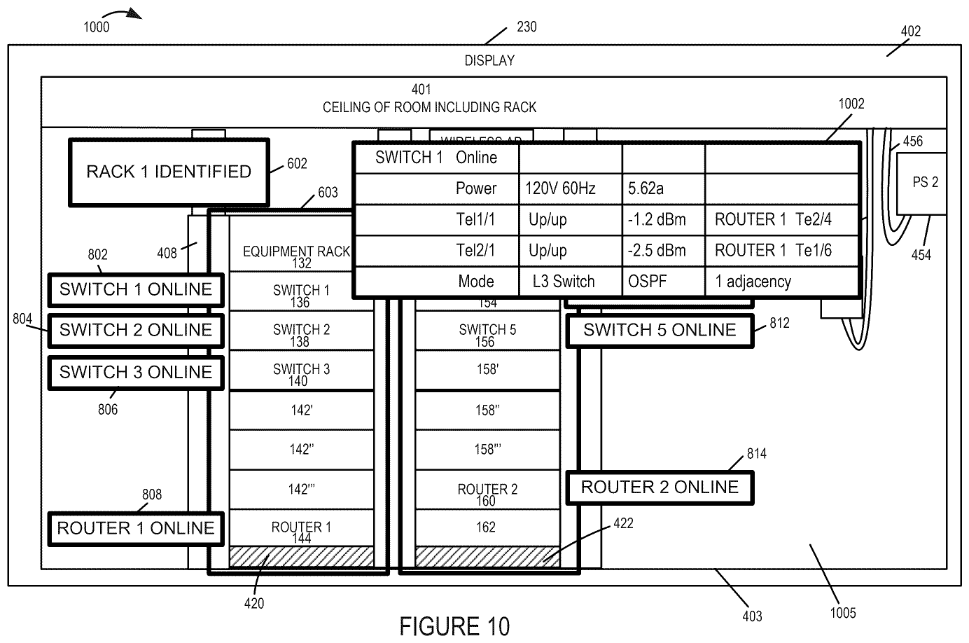

FIG. 10 is a drawing 1000 showing the display 230 of an augmented reality image 1005 with detailed information 1002 corresponding to switch 1 136 which is displayed in response to the user selection shown in FIG. 9 that signaled that the user was seeking detailed information for switch 1 136.

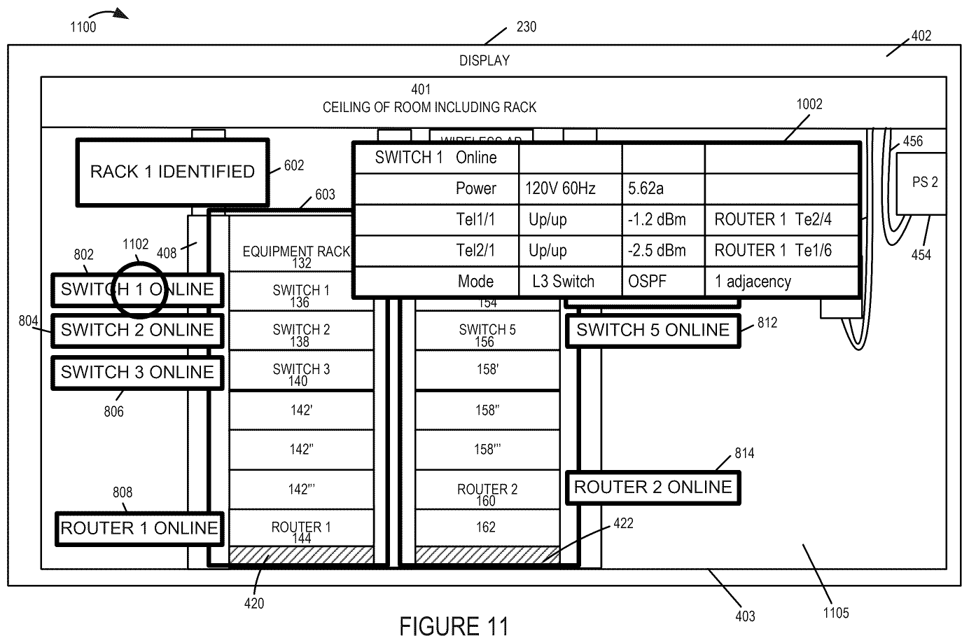

FIG. 11 is a drawing 1100 showing a user providing input, by clicking a single time on the switch 1 label/information 802 while detailed information 1002 corresponding to the switch is displayed, to request that detailed information corresponding to the selected device stop being displayed. The single click is represented in FIG. 11 by circle 1102.

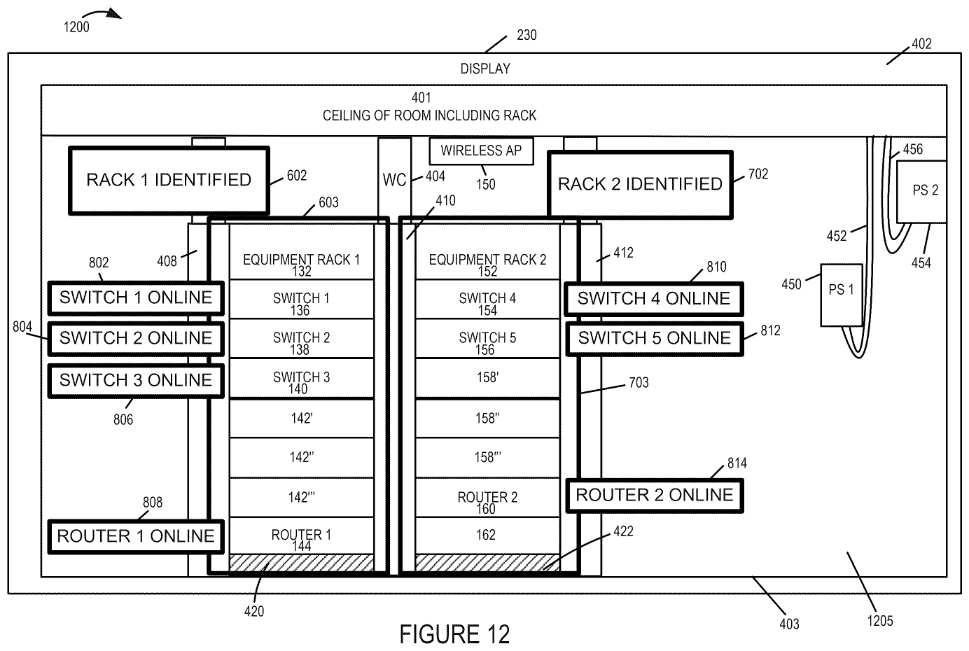

FIG. 12 is a drawing 1200 showing the updated display 230 after the user selected to cease having detailed information corresponding to switch 1 136 displayed. Note that the augmented reality image 1205 is the same as the image 805 shown in FIG. 8.

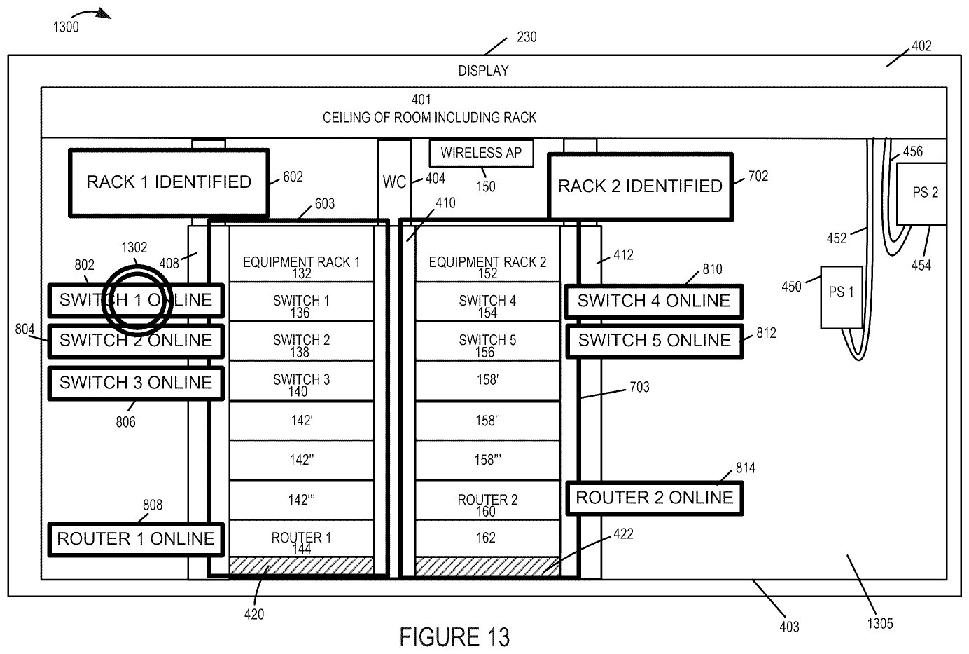

FIG. 13 is a drawing 1300 showing a user providing input, by double clicking on the switch 1 label/information 802 corresponding to switch 1 136 to request that a terminal session with switch 1 136 be initiated. In the displayed augmented reality image 1305 the user input, e.g., double click, used to initiate a terminal session with switch 1 136 is represented by double circles 1302. The session with switch 1 136 is initiated by the AR engine/routine in the mobile device 164 signaling the AR engine of the network management system 108 to trigger the initiation of a terminal session with switch 1 136 through the AR engine 109 of the network management system 108. The AR engine 109 of the network management system 108 acts as an intermediary for the mobile device 164 with regard to the terminal session and provides the mobile device 164 with augmented reality content, e.g., terminal session information, which is then displayed in an augmented reality image on the display device 230.

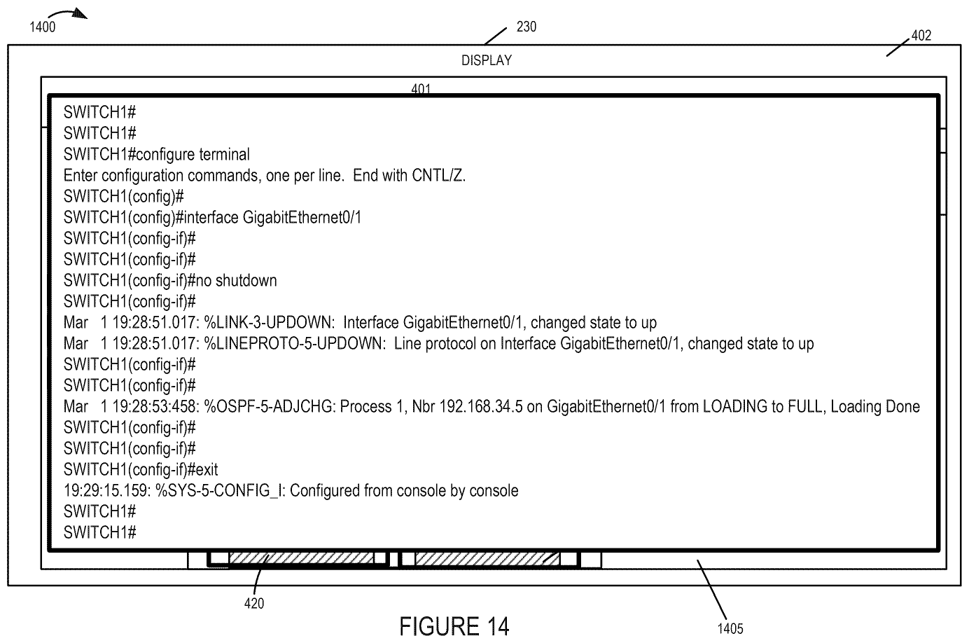

FIG. 14 is a drawing 1400 shows the initiated terminal session with switch 1 136 ongoing on the mobile device 164 with the augmented reality image 1405 being primarily occupied by a terminal session window corresponding to switch 1 136 and with a small portion of the captured image of the room still being visible at the bottom of the display screen 230.

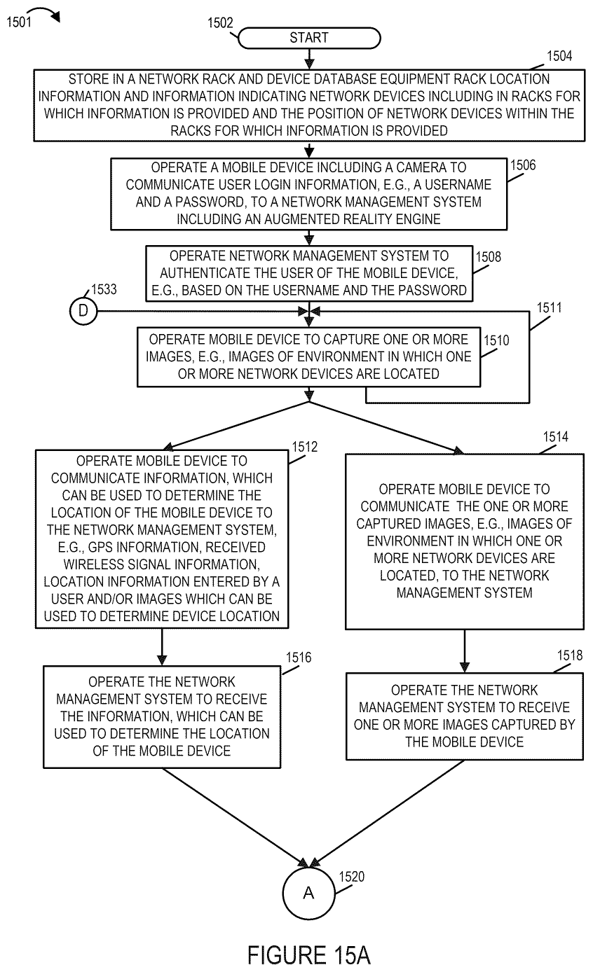

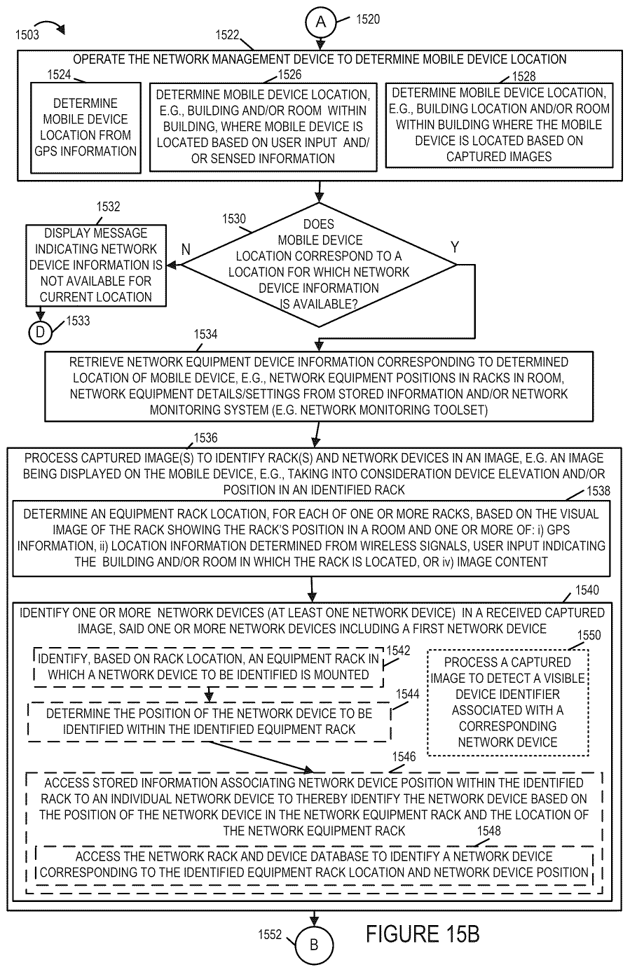

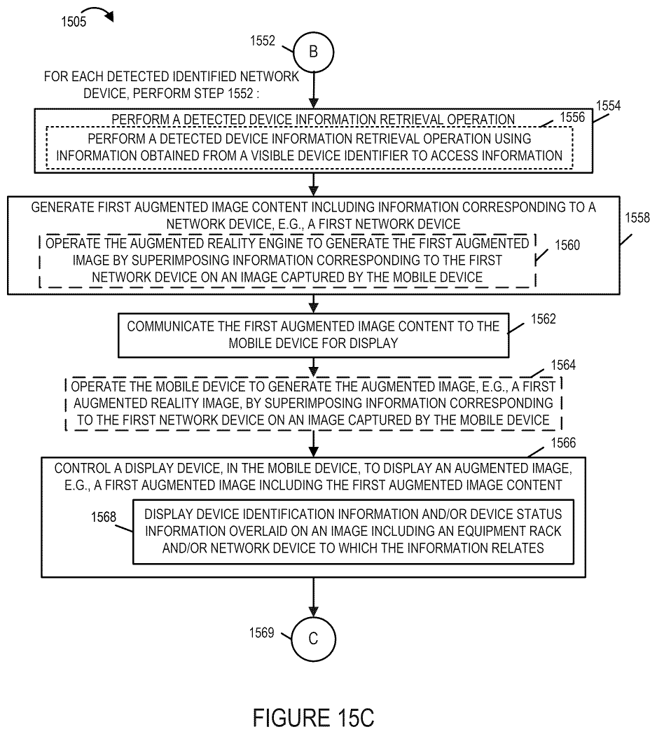

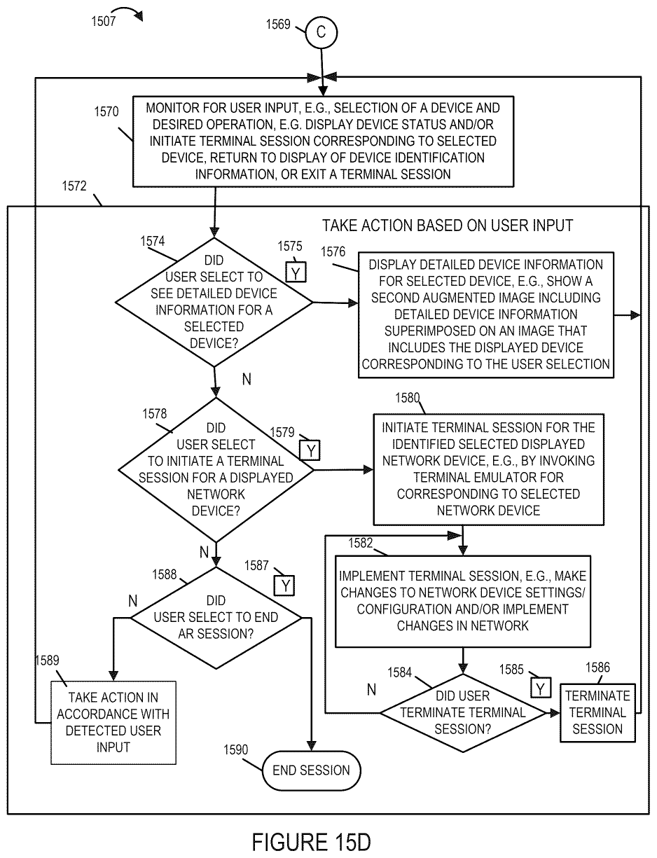

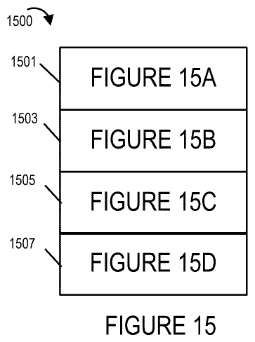

FIG. 15 is a diagram 1500, showing how the diagrams 1501, 1503, 1505 and 1507 of FIGS. 15A, 15B, 15C and 15D, can be combined to form a complete flow chart. The flow chart shows the steps involved in implementing an exemplary method of managing network devices with the use of augmented reality in accordance with one exemplary embodiment of the invention.

The method shown in FIG. 15 starts in step 1502 with the devices in the system 100 being powered on. From start step 1502 operation proceeds to step 1504 in which information is stored in the network rack and device database 102, said stored information including information indicating the location of equipment racks. As part of step 1504 the GPS coordinates, building address, room number, room name, bar code, QR code, rack text identifier and/or other information is stored for each equipment rack in the database 102. In addition, for each rack 132, 152 information indicating the network devices mounted in the rack and the position of the individual devices in the rack is stored in database 102. For example in one embodiment a database entry corresponding to equipment rack 1 includes location information in the form of the GPS and address of Building 1 128, where the rack is located, information indicating that the text label Equipment Rack 1 is used as visible identifier of Rack 1 132 and information indicating that the rack 132 includes network devices: Switch 1 136 mounted in a topmost position in the rack 132, Switch 2 138 mounted in a second from top device position in the rack 132, Switch 3 140 mounted in a third from top device position in the rack 132, and Router 1 144 mounted in a bottommost device position in the rack 132. The label Switch 1 may be, and sometimes is, stored in the database 102 as a visual identifier, which can be used to identify Switch 1 136 when detected in an image, but a QR code, bar code or printed number corresponding to Switch 1 136 and placed on or next to Switch 1 136 may be used instead as a visually detectable, and in some cases unique, network device identifier for which information is stored in database 102, as part of the information corresponding to Rack 1 132. Similar information is stored in the database 102 for other racks such as Rack 2 152. The stored rack and device information is updated in database 102, in some embodiments, as racks and/or network devices are added to, or removed from, the system 100.

With rack and device information having been stored and available for use in identifying racks/devices, operation proceeds from step 1504 to step 1506. In step 1506, a mobile device 164, e.g., a notepad, cellphone, or laptop, with a camera 200 and augmented reality capability, is operated to communicate user login information, e.g., a username and a corresponding password, to network management system 108 with augmented reality capability. This login may be, and sometimes is, part of the process of a user, e.g., a network device manager, logging in to the network management system 108 prior to being permitted to access network device information and/or change network device settings, e.g., via the mobile device 164. The communication between the network management system 108 and mobile device 164 of user login information and subsequent communications, can be by a communications path including a wireless path segment, e.g., via wireless signaling 126 that goes by way of the cellular base station 123 and/or via the wireless signaling 166 that goes by way of wireless AP 150.

Having received the user login information provided in step 1506 in step 1508 the network management system 108 proceeds to authenticate the user of the mobile device 164, e.g., by checking the username and password against stored information accessible to the network management system. The example shown in FIG. 15 assumes that the user authentication in step 1508 is successful with operation shown proceeding to step 1510. If in step 1508 user authentication fails, e.g., because of entry of the wrong password, the user of mobile device 164 would not be allowed to proceed further until they provided a valid username and password.

Operation proceeds from step 1508 to step 1510 upon successful user authentication indicating the user, e.g., network device manager using mobile device 164, is authorized to perform management functions and receive network device information from the network management system 108. In step 1510 the mobile device 164 is operated to capture one or more images, e.g., images of the environment in which one or more network devices are located. This may be, and sometimes is, done by operating the camera 200, which in some embodiments is a rear facing camera which faces out behind and away from the display 230, to capture an image or images. In some embodiments the camera 200 captures video which is a sequence of images. The image capture may be, and sometimes is, an ongoing operation as represented by arrow 1511 going back to the top of image capture step 1510.

With the capture of at least one image, e.g., an image 405 including one or more equipment racks such as the one shown in FIG. 4, operation proceeds from step 1510 to steps 1512 and step 1514 which can be performed in parallel or asynchronously.

In step 1512 the mobile device 164 communicates information, which can be used to determine the location of the mobile device, to the network management system 108. The information can be, for example GPS information, received wireless signal information, location information entered by a user of the mobile device 164, and/or an image or images which can be used to determine device location. In some embodiments the image including the equipment racks may include visible location information such as a unique building/room number and thus the image captured in step 1510 can operate to provide the location information when communicated to the network management system 108. Operation proceeds from step 1512 to step 1516 in which the network management system 108 receives the information which indicates and/or can be used to determine the location of the mobile device 164 and thus the equipment racks/devices captured in the images provided by the mobile device 164. Operation proceeds from step 1516 via connecting node 1520 to step 1522 of FIG. 15B.

Referring once again to step 1514, in this step the mobile device 164 communicates one or more of the captured images, e.g., images of the environment in which one or more network devices are located, to the network management system 108. In embodiments where the images provide the location information, step 1514 serves also as location information and thus steps 1512 and 1514 can be implemented as a single step in some embodiments.

Operation proceeds from step 1514 to step 1518 in which the network management system 108 receives the one or more images captured by the first mobile device 164. Operation proceeds from step 1518 to step 1522 via connecting node A 1520. Thus, by the time step 1522 is performed the network management system has information sufficient to determine the location of the mobile device 164 and one or more images of network devices at the location, e.g., image 405.

In step 1522 the network management system 108 determines the mobile device location from received information which may include one or more images. Depending on the embodiment step 1522 includes one, more than one or all of steps 1524, 1526, 1528. In step 1524 the network management system determines the location of the mobile device 164 from GPS information, e.g., communicated from the mobile device 164 to the network management system 108. In step 1526 the location of the mobile device 164, e.g., building location and/or room within a building, is determined from user input and/or sensed information, e.g., wireless signals, captured by the mobile device or signals from the mobile device 164 detected by another device such as a wireless AP 150 or one or more base stations 123. In step 1528 the location of the mobile device 164, e.g., building location and/or room within the building, is determined based on the content of one or more images captured by the mobile device, e.g., based on an image captured by the mobile device 164 and communicated to the network management system 108.

With the location of the mobile device 164 having been determined, and with the location of the network devices in the image or images captured by the mobile device 164 being the same known location, operation proceeds to step 1530.

In step 1530 a check is made by the network management system 108 as to whether the determined mobile device location corresponds to a location for which network device information is available, e.g., in the database 102. If in step 1530 it is determined that network device information is not available for the location at which the mobile device 164 is located, operation proceeds to step 1532 in which the mobile device 164 is controlled to display a message indicating that network device in not available for the current device location. Operation is shown proceeding from step 1532 to step 1510 via connecting node D 1533 to show that the process is an ongoing operation and that when the mobile device moves to a new location a new image will be captured and the device may be able to be used at the new location to control network devices assuming network device information is available for the new location.

If in step 1530 it is determined that network device information is available for the determined location of the mobile device 164, e.g., because information for the determined location is included in database 102, operation proceeds to step 1534. In step 1534 the network management system 108 retrieves the rack and network device information for the location of the mobile device 164 from the network rack and device database 102. Then in step 1536 the network management system 108 processes one or more captured images, e.g., images provided by the mobile device 164 to identify racks and/or network devices in the individual one or more images. The image which is processed may be an image being displayed to the user of the mobile device. Step 1540 includes one, more than one, or all of steps 1542, 1544, 1546, 1548 and 1550.

In step 1542 the network management system identity, based on rack location, an equipment rack in which a network device to be identified is mounted. Then in step 1544 the position of the network device or devices in the identified rack are determined. Next in step 1546 the stored information associating a network device position within the identified rack to an individual device is accessed to thereby identify the network device(s) in the identified rack given the determined device(s) positions. As part of step 1546, in step 1548,the network management system 108 accesses the network rack and device database 102 to obtain information used in identifying one or more network devices, at the location of the mobile device, in the identified equipment rack based on the position of the network device in the rack. Rather than rely on network device position to identify a network device, one or more network devices can be, and sometimes are, identified by recognizing a visible device identifier associated with a device in the captured image. Step 1550 involves the AR engine 109 of the network management system identifying a visible device identifier, e.g., QR code, bar code, text label, or other device identifier associated with a network device included in a captured image and using the visible identifier to identify the network device.

With racks and one or more devices having been identified, operation proceeds from step 1536 to step 1554 via connecting node B 1552 so that the device related operations will be performed for each identified network device in an image being displayed.

In step 1554 the network management system receives information corresponding to a detected device, e.g., from the network monitoring system 104 which has device status and/or configuration information. In some embodiments step 1554 includes step 1556 in which a visible device identifier, e.g., label, QR code, bar code for example, is used in determining what device information to access/retrieve from the network monitoring system. For example, due to the scanning or detection of a QR code corresponding to Switch 1 136, status and configuration information corresponding to Switch 1 136 will automatically be retrieved in step 1554.

Operation proceeds from step 1554 to step 1558 in which first augmented image content including information corresponds to a network device is generated by the network management system 108. In some cases, the augmented image content is information which is to be superimposed or otherwise combined at the mobile device with a captured image prior to display. The first augmented image content in some cases includes device status information and information where it should be displayed so that the information is clearly associated with the device to which it relates. The images or images with which the first augmented image content is combined may be the image which was used to detect the racks/network devices or another image. In the case of real time AR the first augmented image content can be and sometimes is superimposed on video images as they are captured and displayed.

In some embodiments the first augmented image content is an augmented reality image which is generated in step 1560 at the network management system by combining a captured image received from the mobile device 164 with device identification and/or status information. In such embodiments the mobile device 164 is not burdened with having to generate the augmented reality image or images to be displayed since the superimposing of the device information on a captured image is performed at the network management system 108. This approach has the advantage of reducing the processing burden on the mobile device 164 but can introduce delays in that the captured image on which the device information is superimposed needs to first be communicated to the network management system, augmented and then communicated to the mobile device before it is displayed. In some such embodiments the rate at which augmented reality images are generated is lower than the image/frame capture rate at the mobile device to avoid the need for communicating images to the network management system 108 and returning augmented reality images to the mobile device at the frame capture rate. This can significantly reduce communication and processing burdens as compared to where augmented reality images are generated at the frame rate at which images are normally captured for video purposes. The relatively slow augmented reality image rate, e.g., 1 frame every second or less, is well suited for network device control purposes given that movement of the mobile device 164 is relatively slow and the equipment racks/network devices are normally stationary.

Operation proceeds from step 1562 to step 1566 either directly or via step 1564. Step 1564 is implemented in embodiments where the augmented image content is not a final image but rather information that is to be merged at the mobile device 164 to generate an augmented reality image to be displayed. In step 1564, in those embodiments where it is performed, the mobile device 164 is operated to generate an augmented reality image, e.g., a first augmented reality image, by superimposing device information corresponding to a network device, e.g., a first network device, on an image captured by the mobile device 164.

In step 1566 the display device 230 in the mobile device 164 is controlled to display the augmented reality image including the device information, e.g., to display the first augmented reality image including the first augmented image content including device identification, status and/or configuration information. As part of step 1566, the mobile device performs step 1568 in which device identification information and/or device status information is overlayed on an image of an equipment rack and/or network device in a manner that allows a viewer to easily determine the network device to which the displayed information relates. Augmented reality image 805 shown in FIG. 8 is exemplary for the type of AR image that may be displayed in step 1566.

Operation proceeds from step 1566 via connecting node C 1569 to step 1570 shown in FIG. 15D. In step 1570 the mobile device 164 monitors for user input, e.g., selection of a device and desired operation to be performed, e.g., display detailed device status and/or configuration information and/or initiate a terminal session corresponding to a selected device. Other operations which can be signaled by a user include return to display of device identification and basic status information and exit terminal session. In some embodiments a single click on a label or information corresponding to an individual network device is used to trigger display of detailed information corresponding to the network device while a double click is used to initiate a terminal session with the device. Device information and/or terminal sessions are implemented through the AR module in the mobile device 164 communicating with the network management system 108 which provides the device configuration information and/or handles terminal session interaction with the network device to which the terminal session relates.

As user input is detected at the mobile device 164 in step 1570 operation proceeds to step 1570 which is responsible for determining the user operation being requested by the user input and then controlling the mobile device 164 to implement or initiate the requested user operation.

Step 1572 includes one or more user input checks to determine the action to be taken in response to the detected user input. In step 1574 a check is made to whether the user selected to see detailed device information for a selected device. If the answer is no (N), operation proceeds to step 1578. However, if in step 1574 it is determined that the user selected to see detailed device information for a selected device, e.g., by clicking as shown in FIG. 9 on the Switch 1 label 802, the determination will be that the user selected to see detailed device information as represented by yes (Y) decision box 1575 and operation proceeds to step 1576 in which detailed device information is displayed for the selected device. FIG. 10 shows an exemplary augmented reality image 1005 which includes detailed device status and/or configuration information 1002 for user selected network device Switch 1 136. The FIG. 10 image is exemplary of the image which may be displayed in step 1576. Operation is shown proceeding from step 1576 to step 1570 to show that user input is monitored for on an ongoing basis and that the mobile device will respond as the user provides input.

In decision step 1578 a check is made as to whether the user selected to initiate a terminal session. If the answer in step 1578 is no (N), operation proceeds to step 1586 but if the answer is yes as represented by decision step 1579, operation process to step 1580. In step 1580 a terminal session is initiated for the identified selected network device. FIG. 14 represents an exemplary augmented reality image which shows an ongoing terminal session with Switch 1 in response to a user double clicking on the table 802 as shown in FIG. 13. The image shown in FIG. 14 involving a terminal session is what may be displayed during an initiated terminal session. A user can make changes to network device settings during the terminal session. In step 1582 the mobile device 164, network manager 108 and/or device to which the terminal session relates, e.g., switch 1 136 implements changes made by the network device administrator or take other actions as part of the terminal session. The terminal session will continue until the user terminates the terminal session. Step 1584 represents a check for user input indicating that the terminal session is to be terminated. If the user does not terminate the session the session will remain ongoing, and user changes will be made as indicated by the arrow following the no (N) decision path from step 1584 going back to step 1582. However, if the user indicated that the initiated terminal session is to be terminated, the terminal session will be terminated in step 1586, but operation will remain ongoing as represented by the arrow leaving step 1586 and going to step 1570.

In step 1588 a check is made to determine if the user selected to end the augmented reality session. If the answer in step 1588 is no (N), the operation proceeds to step 1589 where action is taken in accordance with the received user input before operation continues as represented by the arrow exiting box 1589 going to step 1570.

If in step 1588 it is determined that the user selected to end the AR session as indicated by a yes determination 1587, operation proceeds from step 1586 to step 1590 in which an AR session initiated by a user of the mobile device 164 by the login to the network management system, e.g., to manage network devices, is terminated. In some embodiments, termination of the AR session involves an automatic log out of the user device from the network management system 108 and termination of communication between the AR engine 109 of the network management system and the mobile device.

The methods and apparatus described herein provides an AR solution that can allow a tablet or mobile device to display an image of a rack with network equipment that was captured by a camera and with augmented information/tables overlaid thereon to provide device information in a live environment, e.g., at a customer premises in real time or near real time.

In various embodiments GPS data and/or other information is used to determine the location of the user and thus the equipment with the location information then being used to access a database including an inventory of network devices at the location which may also include rack and position information relating to the devices in the inventory.

Once a device in a captured image is identified, network device information such as CPU or memory utilization, temperature, up/down interfaces, active alerts/alarms, connected devices, interface utilization, input voltages, etc., can be and sometimes are displayed as part of an augmented reality image for devices in a captured image. A user is allowed to select a device visible in a captured image, such as a router or switch, and start a terminal emulator to allow remote management and configuration of the device as part of a terminal session, just as if the user were connected to the network device via traditional terminal emulation methods.

### List of Numbered Exemplary Method Embodiments

Method Embodiment 1. A method of managing (e.g., controlling) one or more network devices (e.g., routers, switches, access points, etc.), the method comprising: receiving (1518), at a network management system including an augmented reality engine, one or more images captured by a mobile device; identifying (1540) one or more network devices in a received captured image, said one or more network devices including a first network device; generating (1558) augmented image content including information corresponding to the first network device (e.g., generate image content to be superimposed on a captured image along with information indicating where the image content is to be positioned in a captured image being displayed so that the mobile device can merge the first augmented image content with a captured image prior to display or generate an augmented version of a captured image, e.g., an image displaying one or more network devices including the first network device and information corresponding to the first network device); controlling (1566) a display device in the mobile device to display (e.g., on a display included in the mobile device) a first augmented image including the first augmented image content (e.g., display an image including the first network device and information corresponding to the first network device which was generated in the mobile device by merging the augmented image content with a captured image including the first network device or display an image which includes information corresponding to the first network device along with the information about the first network device where the first augmented image content is a complete image. The first augmented image may be one of multiple sequential images displayed as the user of the mobile device captures images and with information corresponding to the network devices being added to the images prior to display to the user, e.g., as a sequence of augmented reality images).

Method Embodiment 1A. The method of Method Embodiment 1, further comprising: operating (1510) the mobile device (e.g., notepad device or cellphone) including a camera to capture one or more images of an environment in which the one or more network devices are located (e.g., video which includes a sequence of images captured in the area, e.g., equipment room, in which the mobile device is located); and operating (1514) the mobile device to communicate the captured images to the network management system.

Method Embodiment 1B. The method of Method Embodiment 1A, wherein generating first augmented image content is performed by the augmented reality engine, the method further comprising: communicating (1562) the first augmented image content to the mobile device for display.

Method Embodiment 1C. The method of Method Embodiment 1B, wherein the first augmented image content is the first augmented image; and wherein generating (1558) first augmented image content includes operating (1560) the augmented reality engine to generate the first augmented image by superimposing information corresponding to the first network device on an image captured by the mobile device.

Method Embodiment 1D. The method of Method Embodiment 1B, wherein the first augmented image content includes information corresponding to the first network device and information indicating where the information corresponding to the first network device should be superimposed on an image captured by the mobile device (e.g., on an image including the first network device which could be the image used to identify the first network device or a subsequently captured image); and wherein the method further comprises: operating (1564) the mobile device to generate the first augmented image by superimposing information corresponding to the first network device on an image captured by the mobile device.

Method Embodiment 1E. The method of Method Embodiment 1, wherein said information corresponding to the first network device includes: i) device identification information corresponding to the first network device, ii) device status information corresponding to the first network device or iii) both device identification information and device status information (e.g., identification and/or status information corresponding to the first network device is superimposed on a captured image by an augmented reality engine with the information being placed on or next to the first network device so an individual viewing the image can easily determine the device to which the information relates).

Method Embodiment 1F. The method of Method Embodiment 1, further comprising: operating (1506) the mobile device to communicate user login information (e.g., user ID and a password as part of a login procedure used to authenticate the user of the mobile device before the network management system allows the user to initiate management sessions or receive network device information at the mobile device from the network management system) to the network management system prior to the mobile device providing one or more images captured by the mobile device to the network management system.

Method Embodiment 1G. The method of Method Embodiment 1F, further comprising: operating (1508) the network management system to authenticate the user of the mobile device based on a username and a password prior to providing network device information to the mobile device.

Method Embodiment 2. The method of Method Embodiment 1, wherein identifying (1540) at least one network device in the captured image includes: identifying (1542), based on equipment rack location (e.g., building address or GPS location, room and/or position within a room), an equipment rack in which a network device to be identified is mounted; determining (1544) the position of the network device to be identified within the identified equipment rack (e.g., determine which vertical location/equipment slot within the identified equipment rack a network device is located); and accessing (1546) stored information associating (e.g., mapping) network device position within the identified equipment rack to an individual network device (e.g., a network device identified by a network device identifier) to thereby identify the network device based on the position of the network device in the network equipment rack and the location of the network equipment rack.

Method Embodiment 2A. The method of Method Embodiment 2, further comprising: storing (1504) in a network rack and device database (102) equipment rack location information (address or GPS location, room and/or rack position within a room) and information indicating network devices included in racks for which information is provided and the position of the network devices within the racks for which information is provided; and wherein accessing (1546) stored information associating (e.g., mapping) network device position within the identified equipment rack to an individual network device includes accessing (1548) the network rack and device database to identify a network device corresponding to the identified equipment rack location and network device position.

Method Embodiment 3. The method of Method Embodiment 2, further comprising: determining (1538) the equipment rack location based on the visual image of the rack showing the racks position in a room (e.g., position along a wall in the room in which the rack is located) and one or more of i) GPS information (e.g., used to determine the building and/or room in which the rack is located), ii) location information determined from wireless signals, iii) user input indicating the building and room in which the rack is located, or iv) image content, e.g., a room number or other area identifier.

Method Embodiment 4. The method of Method Embodiment 1, wherein identifying (1540) at least one network device in the captured image includes: processing (1550) a captured image to detect a visible device identifier (e.g., QR codes, printed numbers or another identifier on a label located on or next to the network device to which the identifier label corresponds) associated with a corresponding network device.

Method Embodiment 5. The method of Method Embodiment 2, further comprising: performing (1556) a detected device information retrieval operation using information obtained from a visible device identifier to access information (e.g., device name and/or status information is retrieved from a network device database by using the detected visible device identifier or information included in the visible device identifier to access and retrieve information corresponding to the identified network device).

Method Embodiment 6. The method of Method Embodiment 1, further comprising: monitoring for user input (1570); and taking an action (1572) based on the user input.

Method Embodiment 7. The method of Method Embodiment 6, wherein taking an action (1572) based on the user input includes: determining (1574), based on the user input (e.g., a left or right mouse click, or single or double tap, on the portion of the image corresponding to an identified device shown in the image) if the user selected to see detailed device information corresponding to a displayed device corresponding to the user input (e.g., a left mouse click or single tap on an identified device indicates display of detailed device information has been selected to the device on which the click or single tap was associated); and in response to determining that the user selected to see detailed device information (Y 1575), showing (1576) a second augmented image including detailed device information superimposed on an image that includes the displayed device corresponding to the user selection (e.g., the device on which the user left clicked or single tapped).

Method Embodiment 8. The method of Method Embodiment 6, further comprising: determining (1578), based on the user input (e.g., a left or right mouse click, or single or double tap, on the portion of the image corresponding to an identified device shown in the image) if the user selected to initiate a terminal session for a displayed network device corresponding to the user input (e.g., a right mouse click or double tap on an identified device indicates that the user has selected to initiate a terminal session corresponding to the identified device on which the right mouse click or double tap was associated); and in response to determining that the user selected to initiate a terminal session for the identified displayed network device corresponding to the user input (Y 1579), initiating (1580) a terminal session for the identified displayed network device corresponding to the user input.

Method Embodiment 9. The method of Method Embodiment 8, further comprising: making (1588) a change affecting the communications network in accordance with user input received during the terminal session (but possibly more than one or all of), said change being: i) a change to a network device setting corresponding to the displayed network device for which the terminal session was initiated, ii) a change to configuration information corresponding to the displayed network device for which the terminal session was initiated or iii) a network change relating to the displayed network device for which the terminal session was initiated.

Method Embodiment 10. The method of Method Embodiment 6, further comprising: determining (Y 1585) from user input that a terminal session corresponding to a displayed network device for which a terminal session was initiated is to be terminated; and terminating (1586) the terminal session.

Method Embodiment 11. The method of Method Embodiment 6, further comprising: monitoring (1570—second iteration) for additional user input corresponding to a displayed identified network device; and taking (1572—second iteration) an action based on additional user input detected by said monitoring.

### List of Numbered Exemplary Apparatus Embodiments

Apparatus Embodiment 1. A system (100) for managing (e.g., controlling) one or more network devices (e.g., routers, switches, access points, etc.), the system comprising: a network management system (108) including: an augmented reality engine (109), a communications interface (320), and a first processor (348) configured to operate the network management system to: receive (1518), via the communications interface, one or more images captured by a mobile device (164); identify (1540) one or more network devices in a received captured image, said one or more network devices including a first network device (136); and generate (1558) augmented image content including information corresponding to the first network device (e.g., generate image content to be superimposed on a captured image along with information indicating where the image content is to be positioned in a captured image being displayed so that the mobile device can merge the first augmented image content with a captured image prior to display or generate an augmented version of a captured image, e.g., an image displaying one or more network devices including the first network device and information corresponding to the first network device.

Apparatus Embodiment 1A. The system (100) of Apparatus Embodiment 1, wherein said second processor (248) is further configured to: operate (1510) the camera (200) in mobile device (e.g., notepad device or cellphone) to capture one or more images of an environment in which the one or more network devices (136, 138, 140, 144, 154, 156, 160), are located (e.g., video which includes a sequence of images captured in the area, e.g., equipment room, in which the mobile device is located); and operating (1514) the mobile device (164) to communicate (via the mobile device's communications interface) the captured images to the network management system (108).

Apparatus Embodiment 1B. The system (100) of Apparatus Embodiment 1A, wherein the first processor (348) is configured to: operate the augmented reality engine (109) to generate the first augmented image content, as part of being configured to operate the network management system (108) to generate first augmented image content; and operate the network management system (108) to communicate (1562) (via the communications interface) the first augmented image content to the mobile device (164) for display.

Apparatus Embodiment 1C. The system (100) of Apparatus Embodiment 1B, wherein the first augmented image content is the first augmented image; and wherein the first processor (348) is configured to operate (1560) the augmented reality engine (109) to generate the first augmented image by superimposing information corresponding to the first network device (136) on an image captured by the mobile device (164), as part of being configured to operate the network management system (108) to generate (1558) first augmented image content.

Apparatus Embodiment 1D. The system (100) of Apparatus Embodiment 1B, wherein the first augmented image content includes information corresponding to the first network device (136) and information indicating where the information corresponding to the first network device should be superimposed on an image captured by the mobile device (e.g., on an image including the first network device which could be the image used to identify the first network device or a subsequently captured image); and wherein the second processor (248) is further configured to: operate (1564) the mobile device (164) to generate the first augmented image by superimposing information corresponding to the first network device (136) on an image captured by the mobile device (164).

Apparatus Embodiment 1E. The system (100) of Apparatus Embodiment 1, wherein said information corresponding to the first network device (136) includes: i) device identification information corresponding to the first network device, ii) device status information corresponding to the first network device or, iii) both device identification information and device status information (e.g., identification and/or status information corresponding to the first network device is superimposed on a captured image by an augmented reality engine with the information being placed on or next to the first network device so an individual viewing the image can easily determine the device to which the information relates).

Apparatus Embodiment 1F. The system (100) of Apparatus Embodiment 1, wherein said second processor (248) is further configured to: operate (1506) the mobile device (164) to communicate (via its communications interface) user login information (e.g., user ID and a password as part of a login procedure used to authenticate the user of the mobile device before the network management system allows the user to initiate management sessions or receive network device information at the mobile device from the network management system) to the network management system prior to the mobile device (164) providing one or more images captured by the mobile device to the network management system (108).

Apparatus Embodiment 1G. The system (100) of Apparatus Embodiment 1F, wherein said first processor (348) is further configured to: operate (1508) the network management system (108) to authenticate the user of the mobile device (164) based on a username and a password prior to providing network device information to the mobile device (164).

Apparatus Embodiment 2. The system (100) of Apparatus Embodiment 1, wherein said first processor (348) is further configured to: identify (1542), based on equipment rack location (e.g., building address or GPS location, room and/or position within a room), an equipment rack in which a network device to be identified is mounted; determine (1544) the position of the network device to be identified within the identified equipment rack (e.g., determine which vertical location/equipment slot within the identified equipment rack a network device is located); and access (1546) stored information associating (e.g., mapping) network device position within the identified equipment rack to an individual network device (e.g., a network device identified by a network device identifier) to thereby identify the network device based on the position of the network device in the network equipment rack and the location of the network equipment rack, as part of being configured to operate the network management system (108) to identify (1540) at least one network device in the captured image.

Apparatus Embodiment 2A. The system (100) of Apparatus Embodiment 2, further comprising: a network rack and device database (102) storing equipment rack location information (address or GPS location, room and/or rack position within a room) and information indicating network devices included in racks for which information is provided and the position of the network devices within the racks for which information is provided; and wherein said first processor (348) is configured to: operate the network management system (108) to access (1548) the network rack and device database (102) to identify a network device corresponding to the identified equipment rack location and network device position, as part of being configured to operate the network management system (108) to access (1546) stored information associating (e.g., mapping) network device position within the identified equipment rack to an individual network device.

Apparatus Embodiment 3. The system (100) of Apparatus Embodiment 2, wherein said first processor (348) is further configured to: determine (1538) the equipment rack location based on the visual image of the rack showing the racks position in a room (e.g., position along a wall in the room in which the rack is located) and one or more of i) GPS information (e.g., used to determine the building and/or room in which the rack is located), ii) location information determined from wireless signals, iii) user input indicating the building and room in which the rack is located, or iv) image content, e.g., a room number or other area identifier.

Apparatus Embodiment 4. The system (100) of Apparatus Embodiment 1, wherein said first processor (348) is configured to: process (1550) a captured image to detect a visible device identifier (e.g., QR codes, printed numbers, or another identifier on a label located on or next to the network device to which the identifier label corresponds) associated with a corresponding network device, as part of being configured to identify (1540) at least one network device in the captured image.

Apparatus Embodiment 5. The system (100) of Apparatus Embodiment 2, wherein said first processor (348) is configured to: perform (1556) a detected device information retrieval operation using information obtained from a visible device identifier to access information (e.g., device name and/or status information is retrieved from a network device database by using the detected visible device identifier or information included in the visible device identifier to access and retrieve information corresponding to the identified network device).

Apparatus Embodiment 6A. The system of Apparatus Embodiment 1, further comprising: said mobile device (164), said mobile device including: a camera (200), a display device (230), a communications interface (220, 222 or 228), and a second processor (248) being configured to control (1566) the display device in the mobile device to display (e.g., on a display included in the mobile device) a first augmented image including the first augmented image content (e.g., display an image including the first network device and information corresponding to the first network device which was generated in the mobile device by merging the augmented image content with a captured image including the first network device or display an image which includes information corresponding to the first network device along with the information about the first network device where the first augmented image content is a complete image. The first augmented image may be one of multiple sequential images displayed as the user of the mobile device captures images and with information corresponding to the network devices being added to the images prior to display to the user, e.g., as a sequence of augmented reality images).

Apparatus Embodiment 6. The system (100) of Apparatus Embodiment 6A, wherein said second processor (248) is further configured to operate the mobile device (164) to: monitor for user input (1570); and take an action (1572) based on the user input.

Apparatus Embodiment 7. The system (100) of Apparatus Embodiment 6, wherein said second processor (248) is configured to: determine (1574), based on the user input (e.g., a left or right mouse click, or single or double tap, on the portion of the image corresponding to an identified device shown in the image) if the user selected to see detailed device information corresponding to a displayed device corresponding to the user input (e.g., a left mouse click or single tap on an identified device indicates display of detailed device information has been selected to the device on which the click or single tap was associated), as part of being configured to operate the mobile device to take an action (1572) based on the user input; and in response to determining that the user selected to see detailed device information (Y 1575), operate the mobile device (164) to show (1576) a second augmented image including detailed device information superimposed on an image that includes the displayed device corresponding to the user selection (e.g., the device on which the user left clicked or single tapped).

Apparatus Embodiment 8. The system (100) of Apparatus Embodiment claim 6, wherein said second processor (248) is further configured to: determine (1578), based on the user input (e.g., a left or right mouse click, or single or double tap, on the portion of the image corresponding to an identified device shown in the image) if the user selected to initiate a terminal session for a displayed network device corresponding to the user input (e.g., a right mouse click or double tap on an identified device indicates that the user has selected to initiate a terminal session corresponding to the identified device on which the right mouse click or double tap was associated); and in response to determining that the user selected to initiate a terminal session for the identified displayed network device corresponding to the user input (Y 1579), operate the mobile device (164) to initiate (1580) a terminal session for the identified displayed network device corresponding to the user input.

Apparatus Embodiment 9. The system (100) of Apparatus Embodiment 8, wherein said first processor (348) is further configured to operate the network management system (108) to: make (1582) a change affecting the communications network in accordance with user input received during the terminal session (but possibly more than one or all of), said change being: i) a change to a network device setting corresponding to the displayed network device for which the terminal session was initiated, ii) a change to configuration information corresponding to the displayed network device for which the terminal session was initiated or, iii) a network change relating to the displayed network device for which the terminal session was initiated.

Apparatus Embodiment 10. The system (100) of Apparatus Embodiment 6, wherein said second processor (248) is further configured to: determine (Y 1585) from user input that a terminal session corresponding to a displayed network device for which a terminal session was initiated is to be terminated; and terminate (1586) the terminal session.

Apparatus Embodiment 11. The system (100) of Apparatus Embodiment 6, wherein said second processor (248) is further configured to operate the mobile device (164) to: monitor (1570—second iteration) for additional user input corresponding to a displayed identified network device; and take (1572—second iteration) an action based on additional user input detected by said monitoring.

### List of Numbered Exemplary Machine Readable Embodiments

Non-transitory Machine Readable Embodiment 1. A non-transitory machine readable medium including computer executable instructions, which when executed by a processor of a network management system (108) control the network management system to: receive (1518), via the communications interface, one or more images captured by a mobile device (164); identify (1540) one or more network devices in a received captured image, said one or more network devices including a first network device (136); and generate (1558) augmented image content including information corresponding to the first network device (e.g., generate image content to be superimposed on a captured image along with information indicating where the image content is to be positioned in a captured image being displayed so that the mobile device can merge the first augmented image content with a captured image prior to display or generate an augmented version of a captured image, e.g., an image displaying one or more network devices including the first network device and information corresponding to the first network device.

The techniques of various embodiments may be implemented using

software, hardware and/or a combination of software and hardware. Various embodiments are directed to apparatus, e.g., user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices. Various embodiments are also directed to methods, e.g., method of controlling and/or user devices, e.g., compute and display devices supporting augmented and/or mixed reality, e.g., cell phones, note pads, smartphones, lightweight AR glasses, mixed reality (MR) head mounted display (HMD) devices, or a virtual reality (VR) head mounted display (HMD) devices utilizing augmented reality (AR) pass through, display devices, access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices. Various embodiments are also directed to a machine, e.g., computer, readable medium, e.g., ROM, RAM, CDs, hard discs, etc., which include machine readable instructions for controlling a machine to implement one or more steps of a method, e.g., any one of the methods described herein. The computer readable medium is, e.g., non-transitory computer readable medium. It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., user devices, e.g., cell phones, notepads, compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices, access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices, described herein are implemented using one or more components to perform the steps corresponding to one or more methods. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices such as a monitor including an embedded set top box (STB), access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices, include a processor configured to control the device to perform steps in accordance with one of the methods described herein.

The configuration of the processor may be achieved by using one or more components, e.g., software components, to control processor configuration and/or by including hardware in the processor, e.g., hardware components, to perform the recited steps and/or control processor configuration.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices such as a monitor including an embedded set top box (STB), access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices, for example, but could be in other devices as well. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of managing one or more network devices, the method comprising:
receiving, at a network management system including an augmented reality engine, one or more images captured by a mobile device;
identifying one or more network devices in a received captured image, said one or more network devices including a first network device;
generating augmented image content including information corresponding to the first network device; and
controlling a display device in the mobile device to display a first augmented image including the first augmented image content.

2. The method of claim 1, wherein identifying at least one network device in the captured image includes:
identifying, based on equipment rack location, an equipment rack in which a network device to be identified is mounted;
determining the position of the network device to be identified within the identified equipment rack; and
accessing stored information associating network device position within the identified equipment rack to an individual network device to thereby identify the network device based on the position of the network device in the network equipment rack and the location of the network equipment rack.

3. The method of claim 2, further comprising:
determining the equipment rack location based on the visual image of the rack showing the racks position in a room and one or more of i) GPS information, ii) location information determined from wireless signals, iii) user input indicating the building and room in which the rack is located, or iv) image content, e.g., a room number or other area identifier.

4. The method of claim 1, wherein identifying at least one network device in the captured image includes:
processing a captured image to detect a visible device identifier associated with a corresponding network device.

5. The method of claim 2, further comprising:
performing a detected device information retrieval operation using information obtained from a visible device identifier to access information.

6. The method of claim 1, further comprising:
monitoring for user input; and
taking an action based on the user input.

7. The method of claim 6, wherein taking an action based on the user input includes:
determining, based on the user input if the user selected to see detailed device information corresponding to a displayed device corresponding to the user input; and
in response to determining that the user selected to see detailed device information, showing a second augmented image including detailed device information superimposed on an image that includes the displayed device corresponding to the user selection.

8. The method of claim 6, further comprising
determining, based on the user input if the user selected to initiate a terminal session for a displayed network device corresponding to the user input; and
in response to determining that the user selected to initiate a terminal session for the identified displayed network device corresponding to the user input, initiating a terminal session for the identified displayed network device corresponding to the user input.

9. The method of claim 8, further comprising:
making a change affecting the communications network in accordance with user input received during the terminal session, said change being: i) a change to a network device setting corresponding to the displayed network device for which the terminal session was initiated, ii) a change to configuration information corresponding to the displayed network device for which the terminal session was initiated or iii) a network change relating to the displayed network device for which the terminal session was initiated.

10. The method of claim 6, further comprising:
determining from user input that a terminal session corresponding to a displayed network device for which a terminal session was initiated is to be terminated; and
terminating the terminal session.

11. The method of claim 6, further comprising:
monitoring for additional user input corresponding to a displayed identified network device; and
taking an action based on additional user input detected by said monitoring.

12. A system for managing one or more network devices, the system comprising:
a network management system including:
an augmented reality engine,
a communications interface, and
a first processor configured to operate the network management system to:
receive, via the communications interface, one or more images captured by a mobile device;
identify one or more network devices in a received captured image, said one or more network devices including a first network device; and
generate augmented image content including information corresponding to the first network device.

13. The system of claim 12,
wherein said first processor is further configured to:
identify, based on equipment rack location, an equipment rack in which a network device to be identified is mounted;
determine the position of the network device to be identified within the identified equipment rack (e.g., determine which vertical location/equipment slot within the identified equipment rack a network device is located); and
access stored information associating (e.g., mapping) network device position within the identified equipment rack to an individual network device (e.g., a network device identified by a network device identifier) to thereby identify the network device based on the position of the network device in the network equipment rack and the location of the network equipment rack,
as part of being configured to operate the network management system to identify at least one network device in the captured image.

14. The system of claim 13, wherein said first processor is further configured to:
determine the equipment rack location based on the visual image of the rack showing the racks position in a room and one or more of i) GPS information (e.g., used to determine the building and/or room in which the rack is located), ii) location information determined from wireless signals, iii) user input indicating the building and room in which the rack is located, or iv) image content, e.g., a room number or other area identifier.

15. The system of claim 12, wherein said first processor is configured to:
process a captured image to detect a visible device identifier associated with a corresponding network device, as part of being configured to identify (1540) at least one network device in the captured image.

16. The system of claim 13, wherein said first processor is configured to:
perform a detected device information retrieval operation using information obtained from a visible device identifier to access information.

17. The system of claim 12, further comprising:
said mobile device, said mobile device including:
a camera,
a display device,
a communications interface, and
a second processor being configured to control the display device in the mobile device to display a first augmented image including the first augmented image content.

18. The system of claim 17, wherein said second processor is further configured to operate the mobile device to:
monitor for user input; and
take an action based on the user input.

19. The system of claim 18, wherein said second processor is configured to:
determine, based on the user input if the user selected to see detailed device information corresponding to a displayed device corresponding to the user input, as part of being configured to operate the mobile device to take an action based on the user input; and
in response to determining that the user selected to see detailed device information, operate the mobile device to show a second augmented image including detailed device information superimposed on an image that includes the displayed device corresponding to the user selection.

20. The system of claim 18, wherein said second processor is further configured to:
determine, based on the user input if the user selected to initiate a terminal session for a displayed network device corresponding to the user input; and
in response to determining that the user selected to initiate a terminal session for the identified displayed network device corresponding to the user input, operate the mobile device to initiate a terminal session for the identified displayed network device corresponding to the user input.
